(19) United States
(12) Patent Application Publication
(10) Pub. No.: US 2025/0185660 A1
(43) Pub. Date: Jun. 12, 2025

(54) METHODS AND COMPOSITIONS FOR DISRUPTING HERBIVOROUS PESTS AND REDUCING CROP DAMAGE USING PREDATORY INSECT SEMIOCHEMICALS

(71) Applicant: THE PENN STATE RESEARCH FOUNDATION, University Park, PA (US)

(72) Inventors: Sara Lynn Ali, University Park, PA (US); Jessica Tarron Kansman, University Park, PA (US)

(21) Appl. No.: 19/061,046

(22) Filed: Feb. 24, 2025

Related U.S. Application Data
(63) Continuation of application No. PCT/US2023/072830, filed on Aug. 24, 2023.
(60) Provisional application No. 63/373,416, filed on Aug. 24, 2022.

(51) Int. Cl. A01N 43/60; A01N 27/00; A01N 63/14; A01P 17/00

(52) U.S. Cl. CPC A01N 43/60; A01N 27/00; A01N 63/14; A01P 17/00

(57) ABSTRACT

The present disclosure is directed to insect repellant compositions comprising one or more semiochemicals produced by lady beetles. The compositions mimic the pheromones or odor of lady beetles and thus repel aphids and other soft bodied insects that are typically preyed upon by the same. The composition can be used to protect plants, fields, and the like from consumption by these herbivorous insects.

### CROSS REFERENCE TO RELATED APPLICATIONS

This application is a by-pass continuation of PCT/US2023/072830, filed Aug. 24, 2023, which claims priority to provisional application U.S. Ser. No. 63/373,416, filed Aug. 24, 2022, which are incorporated herein by reference in their entireties.

### GOVERNMENT SUPPORT

This invention was made with government support under Grant No. NI21HFPXXXXXG028 awarded by the United States Department of Agriculture. The Government has certain rights in the invention.

### TECHNICAL FIELD

The present disclosure concerns insect repellent compositions and methods of using the same.

### BACKGROUND

Modern agriculture aims to meet increasing food demands imposed by an exponentially growing human population in the face of several hardships, including pesticide resistance, environmental degradation, and global climate change. Therefore, now more than ever, it is crucial to identify novel and sustainable pest management strategies as a central goal of agricultural research.

In particular, utilization of chemical cues derived from plants, microbes, and animals has gained much attention in the realm of sustainable pest management in the past several decades as they have been shown to modulate interactions between crops and their pests. Insect sex pheromones have been used to detect and monitor conspecific pest populations of many hundreds of pest species as a cornerstone integrated pest management (IPM) strategy. Despite the widespread application and efficacy of mating disruption technology in agriculture, the influence of insect pheromones on the behavior of heterospecifics as an IPM tool has received little exploration. Chemical cues from natural enemies (predatory and parasitic species) can play a major role in disrupting herbivore behaviors associated with crop pest damage. While most consideration of the benefits of natural enemies lies in the context of how many pests they consume, the potential for modulation of herbivore anti-predator behavior using natural enemy odors provides a new avenue for suppressing pest damage. Alternative to consumptive effects, natural enemies elicit non-consumptive effects on their prey when the initiation of anti-predator defenses comes at a cost to prey survival and performance.

### SUMMARY

Provided herein are insect repellant compositions comprising a suitable carrier and one or more methoxypyrazines that mimic predatory insect semiochemicals.

According to the disclosure, specific methoxypyrazines and other compounds have been identified that mimic insect predator pheromones or semiochemicals and can be used for insect repellant on plants and in other situations where the same is desired. Thus, in an embodiment the insect repellant compositions of the disclosure include one or more of a methoxypyrazine, and other insect semiochemicals disclosed herein for use in crop production or other areas where insect repellant compositions are traditionally used.

The present disclosure also provides methods for controlling and reducing crop damage by insects.

In another aspect, the disclosure provides a method of repelling an insect pest, preferably one that damages crops and other commercial plant production areas, the method comprising delivering to the crop target an insect repellant composition comprising a carrier and one or more of semiochemicals provided herein.

In yet another aspect, the disclosure provides a kit or formulation for repelling insects comprising a composition as described above and that includes, for example, a plant nutrient or the like.

While multiple embodiments are disclosed, still other embodiments of the present disclosure will become apparent based on the detailed description, which shows and describes illustrative embodiments of the disclosure. Accordingly, the figures and detailed description are to be regarded as illustrative in nature and not restrictive.

### BRIEF DESCRIPTION OF THE DRAWINGS

The following drawings form part of the specification and are included to further demonstrate certain embodiments. In certain embodiments, embodiments can be best understood by referring to the accompanying figures in combination with the detailed description presented herein. The description and accompanying figures may highlight a certain specific example, or a certain embodiment. However, one skilled in the art will understand that portions of the example or embodiment may be used in combination with other examples or embodiments.

FIG. 1A-B shows nymph production (FIG. 1A) and alate formation (FIG. 1B) by M. persicae in a petri dish arena. Aphids were exposed to either a predator-free control or a predator treatment consisting of two H. axyridis ladybeetle predators for three consecutive days (* indicates significance at p<0.05).

FIG. 2A-D shows aphid feeding behavior in the absence (control) or presence (predation risk cue) of lady beetle odor cues over an 8-hour period. Feeding behaviors included time to sustained phloem ingestion (>10 min) (FIG. 2A), duration of phloem ingestion (FIG. 2B), duration of xylem feeding (FIG. 2C), and duration of salivation (FIG. 2D). The boxplot displays the median as a horizontal line, the interquartile range as a box, the maximum and minimum values as bars or “whiskers”, and outliers are indicated with dots. Paired boxplots with * are significantly different based on p<0.05.

FIG. 3 shows aphid population size in the absence (control) or presence (predation risk cue) of lady beetle odor cues after eight days. The boxplot displays the median as a horizontal line, the interquartile range as a box, the maximum and minimum values as bars or “whiskers”, and outliers are indicated with dots. Paired boxplots with * are significantly different based on p<0.05.

FIG. 4 shows a chromatogram of the volatile odors produced by H. axyridis with several candidate compounds indicated.

FIG. 5 shows choice data with winged aphid adults. Blend E, containing the methoxy pyrazines, caused significant aphid-repellance. N=35, C=20, T=6, NC=9. p-value=0.00604.

FIG. 6A-B shows an aphid distribution assay. FIG. 6A is a schematic of the experimental design. Ten aphids were introduced into the petri plate arena and aphid distribution was counted every 5 minutes. FIG. 6B shows a significantly higher number of aphids moved towards the control side, confirming the repellency to blend E. Control-methanol blend, treatment-blend E, N=12.

FIG. 7A-B shows a field experiment on broccoli plants. FIG. 7A shows aphid populations recorded at 2 days post-exposure. t=2.5674, df=14, p-value=0.02235. FIG. 7B shows aphid populations recorded at 7 days post-exposure. t=2.3131, df=10.176, p-value=0.04286. Aphid populations were lower on plants exposed to ladybeetle volatiles than control plants at both timepoints.

### DETAILED DESCRIPTION

Applicants identified a predator semiochemical blend comprising a variety of compounds produced by the lady beetle Harmonia axyridis. Three dominant predator-produced chemicals, all methoxypyrazines, were found in the volatile chemical profile of H. axyridis adults: 2-isopropyl-3-methoxypyrazine (IPMP), 2-sec-butyl-3-methoxypyrazine (SBMP), and 2-isobutyl-3-methoxypyrazine (IBMP). In addition, additional compounds were identified in the semiochemical blend that may be used in combinations with the methoxypyrazines. This composition may be in any form, liquid, gas, or the like. In an embodiment the composition is a liquid or diffusible composition, comprising chemical compounds produced by predatory insects that can be used to minimize damaging behavior of herbivorous insect pests in agricultural cropping systems. The formulation is suitable for application within crop fields or adjacent to crop plants for behavioral modification of herbivorous insect pests and does not have to come in physical contact with the crop plants to function.

So that the present disclosure may be more readily understood, certain terms are first defined. Unless defined otherwise, all technical and scientific terms used herein have the same meaning as commonly understood by one of ordinary skill in the art to which embodiments of the disclosure pertain. Many methods and materials similar, modified, or equivalent to those described herein can be used in the practice of the embodiments of the present disclosure without undue experimentation, the preferred materials and methods are described herein. In describing and claiming the embodiments of the present disclosure, the following terminology will be used in accordance with the definitions set out below.

It is to be understood that all terminology used herein is for the purpose of describing particular embodiments only and is not intended to be limiting in any manner or scope. For example, as used in this specification and the appended claims, the singular forms “a,” “an” and “the” can include plural referents unless the content clearly indicates otherwise. Similarly, the word “or” is intended to include “and” unless the context clearly indicate otherwise. The word “or” means any one member of a particular list and also includes any combination of members of that list. Further, all units, prefixes, and symbols may be denoted in its SI accepted form.

Numeric ranges recited within the specification are inclusive of the numbers defining the range and include each integer within the defined range. Throughout this disclosure, various embodiments of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾. This applies regardless of the breadth of the range.

As used herein, “weight percent,” “wt-%,” “percent by weight,” “% by weight,” and variations thereof refer to the concentration of a substance as the weight of that substance divided by the total weight of the composition and multiplied by 100. It is understood that, as used here, “percent,” “%,” and the like are intended to be synonymous with “weight percent,” “wt-%,” etc.

As used herein, the term “plant” includes all plant populations, including, but not limited to, agricultural, horticultural, ornamental, and silvicultural plants. The term “plant” encompasses plants obtained by conventional plant breeding and optimization methods (e.g., marker-assisted selection) and plants obtained by genetic engineering, including cultivars protectable and not protectable by plant breeders' rights. The term “plant” also encompasses crops.

As used herein, the term “plant cell” refers to a cell of an intact plant, a cell taken from a plant, or a cell derived from a cell taken from a plant. Thus, the term “plant cell” includes cells within seeds, suspension cultures, embryos, meristematic regions, callus tissue, leaves, shoots, gametophytes, sporophytes, pollen, and microspores.

As used herein, the term “plant part” or “plant surface” refers to any part of a plant, including cells and tissues derived from plants. Thus, the term “plant part” may refer to any of plant components or organs (e.g., leaves, stems, roots, etc.), plant tissues, plant cells and seeds. Examples of plant parts, include, but are not limited to, anthers, embryos, flowers, fruits, fruiting bodies, leaves, ovules, pollen, rhizomes, roots, seeds, shoots, stems and tubers, as well as scions, rootstocks, protoplasts, calli and the like.

As used herein, the term “pest” refers to an organism that causes damage to plants, is present where it is not wanted, or is otherwise detrimental to humans, for example, by impacting human agricultural methods or products. Pests may include, for example, herbivorous insects.

As used herein, the term “insect” includes any organism belonging to the phylum Arthropoda and to the class Insecta or the class Arachnida (e.g., mites), in any stage of development, i.e., immature and adult insects.

As used herein, the term “insect repellent” refers to an agent, composition, or substance therein, that deters insects from approaching or remaining on a plant, immobilizes insects, or otherwise alters insect behavior. A repellent may, for example, decrease the number of insects on or in the vicinity of a plant, but may not necessarily kill the insect.

As used herein, “delivering” or “contacting” refers to applying to a plant or insect pest, an insect repellant composition either directly on the plant or insect pest, or adjacent to the plant or insect pest, in a region where the composition is effective to alter the fitness of the plant or insect pest. In methods where the composition is directly contacted with a plant, the composition may be contacted with the entire plant or with only a portion of the plant.

As used herein, “decreasing the fitness of an insect pest” refers to any disruption to insect physiology, or any activity carried out by the insect, as a consequence of administration of an insect repellent composition described herein, including, but not limited to, any one or more of the following desired effects: (1) decreasing a population of an insect pest (e.g., aphid) by about 10%, 20%, 30%, 40%, 50%, 60%, 70%, 80%, 90%, 95%, 99%, 100% or more; (2) decreasing the reproductive rate of an insect pest (e.g., aphid) by about 10%, 20%, 30%, 40%, 50%, 60%, 70%, 80%, 90%, 95%, 99%, 100% or more; (3) decreasing plant infestation by an insect pest (e.g., aphid) by about 10%, 20%, 30%, 40%, 50%, 60%, 70%, 80%, 90%, 95%, 99%, 100% or more. A decrease in insect pest fitness can be determined in comparison to an insect pest to which the insect repellant composition has not been administered.

As used herein, the term “infestation” refers to the presence of insect pests on a plant, a part thereof, or the habitat surrounding a plant, particularly where the infestation decreases the fitness of the plant. A “decrease in infestation” or “treatment of an infestation” refers to a decrease in the number of pests on or around the plant (e.g., by about 1%, 2%, 5%, 10%, 20%, 30%, 40%, 50%, 60%, 70%, 80%, 90%, or % 100) or a decrease in symptoms or signs in the plant that are directly or indirectly caused by the pest (e.g., by about 1%, 2%, 5%, 10%, 20%, 30%, 40%, 50%, 60%, 70%, 80%, 90%, or % 100) relative to an untreated plant. Infestation or associated symptoms can be identified by any means of identifying infestation or related symptoms. For example, the decrease in infestation in one or more parts of the plant may be in an amount sufficient to “substantially eliminate” an infestation, which refers to a decrease in the infestation in an amount sufficient to sustainably resolve symptoms and/or increase plant fitness relative to an untreated plant.

As used herein, “increasing the fitness of a plant” refers to an increase in the production of the plant, for example, an improved yield, improved vigor of the plant or quality of the harvested product from the plant. An improved yield of a plant relates to an increase in the yield of a product (e.g., as measured by plant biomass, grain, seed or fruit yield, protein content, carbohydrate or oil content or leaf area) of the plant by a measurable amount over the yield of the same product of the plant produced under the same conditions, but without the application of the insect repellent compositions of the disclosure or compared with application of conventional pesticides. For example, yield can be increased by at least about 0.5%, about 1%, about 2%, about 3%, about 4%, about 5%, about 10%, about 20%, about 30%, about 40%, about 50%, about 60%, about 70%, about 80%, about 90%, about 100%, or more than 100%. Yield can be expressed in terms of an amount by weight or volume of the plant or a product of the plant on some basis. The basis can be expressed in terms of time, growing area, weight of plants produced, or amount of a raw material used. An increase in the fitness of plant can also be measured by other means, such as an increase or improvement of the vigor rating, the stand (the number of plants per unit of area), plant height, stalk circumference, plant canopy, visual appearance (such as greener leaf color), root rating, emergence, protein content, increased tillering, bigger leaves, more leaves, less dead basal leaves, stronger tillers, less fertilizer needed, less seeds needed, more productive tillers, earlier flowering, early grain or seed maturity, less plant verse (lodging), increased shoot growth, earlier germination, or any combination of these factors, by a measurable or noticeable amount over the same factor of the plant produced under the same conditions, but without the administration of the insect repellent compositions of the disclosure or with application of conventional pesticides.

As used herein, the term “untreated” refers to a plant or insect pest that has not been contacted with or delivered an insect repellant composition, including a separate plant that has not been delivered the insect repellant composition, the same plant undergoing treatment assessed at a time point prior to delivery of the insect repellent compositions, or the same plant undergoing treatment assessed at an untreated part of the plant.

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups).

Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

In certain embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

The term “substantially free” may refer to any component that the composition of the disclosure or a method incorporating the composition lacks or mostly lacks. When referring to “substantially free” it is intended that the component is not intentionally added to compositions of the disclosure. Use of the term “substantially free” of a component allows for trace amounts of that component to be included in compositions of the disclosure because they are present in another component. However, it is recognized that only trace or de minimus amounts of a component will be allowed when the composition is said to be “substantially free” of that component. Moreover, the term if a composition is said to be “substantially free” of a component, if the component is present in trace or de minimus amounts it is understood that it will not affect the effectiveness of the composition. It is understood that if an ingredient is not expressly included herein or its possible inclusion is not stated herein, the disclosure composition may be substantially free of that ingredient. Likewise, the express inclusion of an ingredient allows for its express exclusion thereby allowing a composition to be substantially free of that expressly stated ingredient.

### Insect Repellant Compositions

The insect repellent compositions of the disclosure may include a methoxypyrazine and optionally other semiochemicals that mimic the semiochemicals of lady beetles (e.g., Harmonia axyridis).

The composition may comprise a blend of compounds. When more than one compound is used, the compounds may be present in effective ratios. For example, the compounds may be present in a ratio similar to that found in nature. For example, the composition may comprise a blend of the semiochemicals identified herein. Using more than one compound may extend the range of effective dosages and/or may reduce the amount of total repellant or of a specific repellant effective to repel various soft bodied herbivorous insects.

The insect repellent compositions of the disclosure may include a methoxypyrazine. In certain embodiments, the methoxypyrazine is a methoxypyrazine that is produced by a lady beetle (e.g., Harmonia axyridis). In certain embodiments, the methoxypyrazine is a 3-methoxypyrazine. In certain embodiments, the methoxypyrazine is an alkyl-substituted methoxypyrazine. In certain embodiments, the methoxypyrazine is an alkyl-substituted 3-methoxypyrazine. In certain embodiments, the methoxypyrazine is a 2-alkyl-3-methoxypyrazine. In certain embodiments, the methoxypyrazine is 2-isopropyl-3-methoxypyrazine, 2-sec-butyl-3-methoxypyrazine, 2-isobutyl-3-methoxypyrazine, or a combination thereof.

The insect repellent compositions of the disclosure may include a terpene. In certain embodiments, the terpene is a terpene that is produced by a lady beetle (e.g., Harmonia axyridis). In certain embodiments, the terpene is β-caryophyllene, α-humulene, limonene, α-pinene, or a combination thereof.

In certain embodiments, the insect repellent composition comprises one or more (e.g., 2, 3, 4, 5, 6, 7, 8, 9, 10) of: 2-isopropyl-3-methoxypyrazine; 2-sec-butyl-3-methoxypyrazine; 2-isobutyl-3-methoxypyrazine; β-caryophyllene; α-humulene; limonene; α-pinene; octadecanoic acid; dimethyl sulfone; camphene; 1,2,4-trimethylbenzene; styrene; benzene acetic acid methyl ester; propylbenzene; 2-ethyl-1-hexanol; caprolactam; mesitylene; 2-heptanone; 2-octanone; 1-octanol; eicosane; tetracosane; indole; 3-methyl-1-butanol; decane; 1,4-diethylbenzene; dodecanoic acid; cyclopentadecane; indane; borneal; 2,3-butanediol; acetoin; o-cymene; tetrahydro-2H-pyran-2-one; 3-(methylthio)-1-propanol; terpinolene; 2,3,3-trimethyl-1-butene; pentadecane; heneicosane; docosane; pentacosane; hentriacotane; 2-nonanone; 1-ethyl-2,3-dimethylbenzene; dimethylsilanediol; 4-unadecanone; dehydromevalonic lactone; methyl ester octadeca-9,12-dienoate; geranyl acetone; (Z)-3,7-dimethyl-3,6-octadien-1-ol; 1,3,5-tris(trimethylsiloxy)benzene; 6-methyl-3,4-dihydro-2H-pyran; 5-butylnonane; 1-hexacosene; S-methyl 3-methylbutanethioate; 4-hydroxy 3-(methylamino)benzonitrile; camphene hydrate; 3,7 dimethyl-6-noen-1-ol acetate; 4-(3-hydroxy-2,2,6-trimethyl-7-oxa-bicyclo[4.1.0]hept-1-yl)-but-3-en-2-one; 2-hydrazino-4,6-dimethylpyrimidine, 2TMS derivative; 1-oodododecane.

The composition may be provided in a concentrated form (i.e., in a form that requires dilution prior to use, or which is diluted upon delivery to the site of use) or in a dilute form that is suitable for use in the methods without dilution. For example, the methods of the disclosure, which optionally may be carried out using the compositions of the disclosure, may employ final concentrations of at least about 1 ng, at least about 10 ng, at least about 100 ng, at least about 0.001 mg, at least about 0.01 mg, or at least about 0.1 mg with respect to a single compound or the total of two or more compounds. The composition may comprise less than about 1 mg, less than about 0.1 mg, less than about 0.01 mg, less than about 0.001 mg, less than about 100 ng, or less than about 10 ng of total compound. The methods may employ compounds in a concentration of from about 1 ng to about 100 ng of total compound. The methods may employ final concentrations of compound at the target of at least about 0.03 ng/ml, at least about 0.3 ng/mL, at least about 3.0 ng/ml, or at least about 30 ng/mL. The methods may employ compound in a final concentration of at the target of less than about 300 ng/ml, less than about 30 ng/mL, or less than about 3.0 ng/mL. The methods may employ compound such that the final concentration of compound at the plant target is about 0.03 to about 3.33 ng/ml. It is well within the ability of one skilled in the art to determine an effective concentration for use in the methods of the disclosure.

In certain embodiments, the composition is not meant to be diluted, but is rather a ready to use solution. In some embodiments, the composition can include at least about 80%, at least about 85%, at least about 90%, or at least about 95% by weight of a carrier. It is to be understood that all ranges and values between these ranges and values are included in the present compositions.

To allow ease of application, handling, transportation, storage, and activity, the active agent (e.g., lady beetle semiochemicals) can be formulated with other substances. Semiochemicals can be formulated into, for example, concentrated emulsions, dusts, emulsifiable concentrates, fumigants, gels, granules, microencapsulations, seed treatments, suspension concentrates, suspoemulsions, tablets, water soluble liquids, water dispersible granules or dry flowables, wettable powders, and ultra-low volume solutions. The repellant composition may be in any suitable form, including but not limited to liquid, gas, or solid forms or shapes known in the art such as pellets, particles, beads, tablets, sticks, pucks, briquettes, pellets, beads, spheres, granules, micro-granules, extrudates, cylinders, ingot, and the like. In some embodiments, the composition may be provided in a quick-release composition, an extended-release composition, or a combination thereof. For further information on formulation types see “Catalogue of Pesticide Formulation Types and International Coding System” Technical Monograph n° 2, 5th Edition by CropLife International (2002).

Active agents (e.g., lady beetle semiochemicals, additional pesticides) can be applied as aqueous suspensions or emulsions prepared from concentrated formulations of such agents. Such water-soluble, water-suspendable, or emulsifiable formulations are either solids, usually known as wettable powders, or water dispersible granules, or liquids usually known as emulsifiable concentrates, or aqueous suspensions. Wettable powders, which may be compacted to form water dispersible granules, comprise an intimate mixture of the pesticide, a carrier, and surfactants. The carrier is usually selected from among the attapulgite clays, the montmorillonite clays, the diatomaceous earths, or the purified silicates. Effective surfactants, including from about 0.5% by weight to about 10% by weight of the wettable powder, are found among sulfonated lignins, condensed naphthalenesulfonates, naphthalenesulfonates, alkylbenzenesulfonates, alkyl sulfates, and non-ionic surfactants such as ethylene oxide adducts of alkyl phenols.

The compositions of the disclosure may comprise the repellant compounds encapsulated within, deposited on, or dissolved in a carrier. As used herein, a carrier may comprise a solid, liquid, or gas, or combination thereof. Suitable carriers are known by those of skill in the art. For example, liquid carriers may include, but are not limited to, water, media, glycerol, or other solution. In other embodiments, a water-soluble solvent, such as alcohols and polyols, can be used as a carrier. These solvents may be used alone or with water. Some examples of suitable alcohols include methanol, ethanol, propanol, butanol, and the like, as well as mixtures thereof. Some examples of polyols include glycerol, ethylene glycol, propylene glycol, diethylene glycol, and the like, as well as mixtures thereof. The carrier selected can depend on a variety of factors, including, but not limited to the desired functional properties of the compositions, and/or the intended use of the compositions.

Emulsifiable concentrates can comprise a suitable concentration of semiochemicals dissolved in a carrier that is either a water miscible solvent or a mixture of water-immiscible organic solvent and emulsifiers. Useful organic solvents include aromatics, especially xylenes and petroleum fractions, especially the high-boiling naphthalenic and olefinic portions of petroleum such as heavy aromatic naphtha. Other organic solvents may also be used, such as the terpenic solvents including rosin derivatives, aliphatic ketones such as cyclohexanone, and complex alcohols such as 2-ethoxyethanol. Suitable emulsifiers for emulsifiable concentrates are selected from conventional anionic and non-ionic surfactants.

Aqueous suspensions comprise suspensions of water-insoluble pesticides dispersed in an aqueous carrier at a concentration in the range from about 5% to about 50% by weight. Suspensions are prepared by finely grinding the pesticide and vigorously mixing it into a carrier comprised of water and surfactants. Ingredients, such as inorganic salts and synthetic or natural gums may also be added, to increase the density and viscosity of the aqueous carrier.

Semiochemicals of the disclosure may also be applied as granular compositions that are particularly useful for applications to the soil. Granular compositions usually contain from about 0.5% to about 10% by weight of the pesticide, dispersed in a carrier that comprises clay or a similar substance. Such compositions are usually prepared by dissolving the formulation in a suitable solvent and applying it to a granular carrier which has been pre-formed to the appropriate particle size, in the range of from about 0.5 to about 3 mm. Such compositions may also be formulated by making a dough or paste of the carrier and compound and crushing and drying to obtain the desired granular particle size.

Dusts containing the semiochemicals are prepared by intimately mixing semiochemicals in powdered form with a suitable dusty agricultural carrier, such as kaolin clay, ground volcanic rock, and the like. They can be applied as a seed dressing or as a foliage application with a dust blower machine.

In certain embodiments, the formulation is provided in conjunction with a suitable solid or semi-solid carrier Suitable solid carriers may include, but are not limited to, biodegradable polymers, talcs, attapulgites, diatomites, fullers earth, montmorillonites, vermiculites, synthetics (such as Hi-Sil or Cab-O-Sil), aluminum silicates, apatites, bentonites, limestones, calcium sulfate, kaolinities, micas, perlites, pyrophyllites, silica, tripolites, and botanicals (such as corn cob grits or soybean flour), and variations thereof that will be apparent to those skilled in the art.

The solid carrier can be a macromer, including, but not limited to, ethylenically unsaturated derivatives of poly(ethylene oxide) (PEG) (e.g., PEG tetraacrylate), polyethylene glycol (PEG), polyvinyl alcohol (PVA), poly(vinylpyrrolidone) (PVP), poly(ethyloxazoline) (PEOX), poly(amino acids), polysaccharides, proteins, and combinations thereof. Carriers may also include plaster.

Polysaccharide solid supports include, but are not limited to, alginate, hyaluronic acid, chondroitin sulfate, dextran, dextran sulfate, heparin, heparin sulfate, heparin sulfate, chitosan, gellan gum, xanthan gum, guar gum, water soluble cellulose derivatives, carrageenan, and combinations thereof.

Protein solid supports include, but are not limited to, gelatin, collagen, albumin, and combinations thereof.

In certain embodiments, the solid or semi-solid carrier is a wax, wax-like, gel or gel like material; an absorbent solid material or material capable of having the formulation adsorbed thereon; or a solid matrix capable of having the formulation contained therein. For example, in particular embodiments, the formulation is provided in conjunction with a wax or wax-like carrier (e.g., a wax), particularly wherein the formulation is evenly distributed throughout the wax or wax-like carrier. Particular wax-like carriers that may be mentioned include paraffin (which may be referred to as paraffin wax).

Alternatively, the formulation may be provided in conjunction with an absorbent solid material, such as in a form wherein said formulation is absorbed in (i.e., impregnated in) said solid. For example, the formulation may be absorbed in an absorbent paper or paper-like material, or a fabric material (e.g., a fabric constructed from natural fibers, such as a cotton fabric).

Further, in embodiments wherein the formulation is provided in conjunction with an absorbent solid material, such conjunctions of materials may be prepared by absorbing said formulation into said solid material. Such conjunctions of absorbent solid material and formulations may be provided by absorbing the formulation into the solid material, particularly where the formulation comprises a suitable (e.g., volatile) solvent and, following absorption, said solvent is allowed to evaporate to result in an absorbed formulation comprising a lower amount of (or essentially none of) that solvent.

Alternatively, the formulation may be adsorbed on a solid material and/or contained within a solid matrix of a solid material. For example, the formulation may be adsorbed and/or contained within a plurality of solid beads, such as suitable plastic beads. Particular plastic bead-based carrier systems that may be used include that marketed by BIOGENTS® as the BG-LURE® system/carriage.

It is equally practical to apply the present formulation in the form of a solution in an appropriate organic solvent, usually petroleum oil, such as the spray oils, which are widely used in agricultural chemistry.

Semiochemicals of the disclosure can also be applied in the form of an aerosol composition. In such compositions the semiochemicals are dissolved or dispersed in a carrier, which is a pressure-generating propellant mixture. The aerosol composition is packaged in a container from which the mixture is dispensed through an atomizing valve.

Another embodiment is an oil-in-water emulsion, wherein the emulsion comprises oily globules which are each provided with a lamellar liquid crystal coating and are dispersed in an aqueous phase, wherein each oily globule comprises at least one compound which is agriculturally active, and is individually coated with a monolamellar or oligolamellar layer including: (1) at least one non-ionic lipophilic surface-active agent, (2) at least one non-ionic hydrophilic surface-active agent and (3) at least one ionic surface-active agent, wherein the globules having a mean particle diameter of less than 800 nanometers. Further information on the embodiment is disclosed in U.S. patent publication 20070027034 published Feb. 1, 2007.

Additionally, generally, when the compounds disclosed herein are used in a formulation, such formulation can also contain other components. These components include, but are not limited to, (this is a non-exhaustive and non-mutually exclusive list) wetting agents, spreaders, stickers, penetrants, buffers, sequestering agents, drift reduction agents, compatibility agents, anti-foam agents, cleaning agents, and emulsifiers. A few components are described forthwith.

A wetting agent is a substance that when added to a liquid increases the spreading or penetration power of the liquid by reducing the interfacial tension between the liquid and the surface on which it is spreading. Wetting agents are used for two main functions in agrochemical formulations: during processing and manufacture to increase the rate of wetting of powders in water to make concentrates for soluble liquids or suspension concentrates; and during mixing of a product with water in a spray tank to reduce the wetting time of wettable powders and to improve the penetration of water into water-dispersible granules. Examples of wetting agents used in wettable powder, suspension concentrate, and water-dispersible granule formulations are sodium lauryl sulfate; sodium dioctyl sulfosuccinate; alkyl phenol ethoxylates; and aliphatic alcohol ethoxylates.

A dispersing agent is a substance which adsorbs onto the surface of particles and helps to preserve the state of dispersion of the particles and prevents them from reaggregating. Dispersing agents are added to agrochemical formulations to facilitate dispersion and suspension during manufacture, and to ensure the particles redisperse into water in a spray tank. They are widely used in wettable powders, suspension concentrates and water-dispersible granules. Surfactants that are used as dispersing agents have the ability to adsorb strongly onto a particle surface and provide a charged or steric barrier to reaggregation of particles. The most commonly used surfactants are anionic, non-ionic, or mixtures of the two types. For wettable powder formulations, the most common dispersing agents are sodium lignosulfonates. For suspension concentrates, very good adsorption and stabilization are obtained using polyelectrolytes, such as sodium naphthalene sulfonate formaldehyde condensates.

Tristyrylphenol ethoxylate phosphate esters are also used. Non-ionics such as alkylarylethylene oxide condensates and EO-PO block copolymers are sometimes combined with anionics as dispersing agents for suspension concentrates. In recent years, new types of very high molecular weight polymeric surfactants have been developed as dispersing agents. These have very long hydrophobic ‘backbones’ and a large number of ethylene oxide chains forming the ‘teeth’ of a ‘comb’ surfactant. These high molecular weight polymers can give very good long-term stability to suspension concentrates because the hydrophobic backbones have many anchoring points onto the particle surfaces. Examples of dispersing agents used in agrochemical formulations are: sodium lignosulfonates; sodium naphthalene sulfonate formaldehyde condensates; tristyrylphenol ethoxylate phosphate esters; aliphatic alcohol ethoxylates; alkyl ethoxylates; EO-PO (ethylene oxide-propylene oxide) block copolymers; and graft copolymers.

An emulsifying agent is a substance which stabilizes a suspension of droplets of one liquid phase in another liquid phase. Without the emulsifying agent the two liquids would separate into two immiscible liquid phases. The most commonly used emulsifier blends contain alkylphenol or aliphatic alcohol with twelve or more ethylene oxide units and the oil-soluble calcium salt of dodecylbenzenesulfonic acid. A range of hydrophile-lipophile balance (“HLB”) values from 8 to 18 will normally provide good stable emulsions. Emulsion stability can sometimes be improved by the addition of a small amount of an EO-PO block copolymer surfactant.

A solubilizing agent is a surfactant which will form micelles in water at concentrations above the critical micelle concentration. The micelles are then able to dissolve or solubilize water-insoluble materials inside the hydrophobic part of the micelle. The types of surfactants usually used for solubilization are non-ionics, sorbitan monooleates, sorbitan monooleate ethoxylates, and methyl oleate esters.

Surfactants are sometimes used, either alone or with other additives such as mineral or vegetable oils as adjuvants to spray-tank mixes to improve the biological performance of the pesticide on the target. The types of surfactants used for bioenhancement depend generally on the nature and mode of action of the pesticide. However, they are often non-ionics such as: alkyl ethoxylates; linear aliphatic alcohol ethoxylates; aliphatic amine ethoxylates.

A carrier or diluent in an agricultural formulation is a material added to the pesticide to give a product of the required strength. Carriers are usually materials with high absorptive capacities, while diluents are usually materials with low absorptive capacities. Carriers and diluents are used in the formulation of dusts, wettable powders, granules, and water-dispersible granules.

Organic solvents are used mainly in the formulation of emulsifiable concentrates, oil-in-water emulsions, suspoemulsions, and ultra low volume formulations, and to a lesser extent, granular formulations. Sometimes mixtures of solvents are used. The first main groups of solvents are aliphatic paraffinic oils such as kerosene or refined paraffins. The second main group (and the most common) comprises the aromatic solvents such as xylene and higher molecular weight fractions of C9 and C10 aromatic solvents. Chlorinated hydrocarbons are useful as cosolvents to prevent crystallization of pesticides when the formulation is emulsified into water. Alcohols are sometimes used as cosolvents to increase solvent power. Other solvents may include vegetable oils, seed oils, and esters of vegetable and seed oils.

Thickeners or gelling agents are used mainly in the formulation of suspension concentrates, emulsions, and suspoemulsions to modify the rheology or flow properties of the liquid and to prevent separation and settling of the dispersed particles or droplets. Thickening, gelling, and anti-settling agents generally fall into two categories, namely water-insoluble particulates and water-soluble polymers. It is possible to produce suspension concentrate formulations using clays and silicas. Examples of these types of materials, include, but are not limited to, montmorillonite, bentonite, magnesium aluminum silicate, and attapulgite. Water-soluble polysaccharides have been used as thickening-gelling agents for many years. The types of polysaccharides most commonly used are natural extracts of seeds and seaweeds or are synthetic derivatives of cellulose. Examples of these types of materials include, but are not limited to, guar gum; locust bean gum; carrageenam; alginates; methyl cellulose; sodium carboxymethyl cellulose (SCMC); hydroxyethyl cellulose (HEC). Other types of anti-settling agents are based on modified starches, polyacrylates, polyvinyl alcohol, and polyethylene oxide. Another good anti-settling agent is xanthan gum. When a thickening agent is included in the compositions, the thickening agent may constitute between about 0.01% and about 1.0% by weight, about 0.05% and about 0.5% by weight, or about 0.1% by weight of the composition.

A preservative can optionally be included in an insect repellent composition to prevent degradation of the composition. In certain embodiments, the preservative can also, or alternatively, be a biocide which prevents the growth of bacteria and fungi. Examples of such agents include, but are not limited to: propionic acid and its sodium salt; sorbic acid and its sodium or potassium salts; benzoic acid and its sodium salt; p-hydroxybenzoic acid sodium salt; methyl p-hydroxybenzoate; and 1,2-benzisothiazolin-3-one (BIT). Other suitable preservatives are known in the art.

For example, in particular embodiments that may be mentioned, the composition further comprises one or more component that is an antioxidant. Particular antioxidant compounds that may be mentioned include butylated hydroxytoluene (BHT), which is also known as dibutyl hydroxytoluene.

The presence of surfactants often causes water-based formulations to foam during mixing operations in production and in application through a spray tank. In order to reduce the tendency to foam, anti-foam agents are often added either during the production stage or before filling into bottles. Generally, there are two types of anti-foam agents, namely silicones and non-silicones. Silicones are usually aqueous emulsions of dimethyl polysiloxane, while the non-silicone anti-foam agents are water-insoluble oils, such as octanol and nonanol, or silica. In both cases, the function of the anti-foam agent is to displace the surfactant from the air-water interface.

“Green” agents (e.g., adjuvants, surfactants, solvents) can reduce the overall environmental footprint of crop protection formulations. Green agents are biodegradable and generally derived from natural and/or sustainable sources, e.g., plant and animal sources. Specific examples are vegetable oils, seed oils, and esters thereof, also alkoxylated alkyl polyglucosides.

Plant nutrient components may also be used herein, the term “nutrient” refers to both micronutrients and macronutrients. The source of at least one nutrient may comprise one or more macronutrients, one or more micronutrients, or a combination of both macronutrients and micronutrients. Macronutrients are essential plant nutrients that are required in relatively larger amounts (as compared to micronutrients) for healthy plant growth and development. In contrast, micronutrients are essential plant nutrients that are needed in lesser quantities. In certain embodiments, the source of at least one nutrient comprises a macronutrient selected from the group consisting of nitrogen, phosphorus, potassium, calcium, sulfur, and magnesium. In certain embodiments, the source of at least one nutrient comprises a micronutrient selected from the group consisting of zinc, manganese, iron, boron, chlorine, copper, molybdenum, nickel, cobalt, selenium, and sodium. It should be understood by those of skill in the art that other macronutrients and micronutrients known in the art may also be used in accordance with embodiments of the present disclosure.

Nutrient sources include those selected from the group consisting of sulfates, oxides, chlorides, carbonates, phosphates, nitrates, and chelates of the nutrient. In the instance of chelated sources, the chelating agent is preferably selected from the group consisting of ethylenediaminetetraacetic acid (“EDTA acid”), ethylene diaminetetraacetate (“EDTA”), EDTA salts, and mixtures thereof, and preferably a salt of EDTA. Particularly preferred chelating agents are selected from the group consisting of ammonium salts of EDTA or EDTA acid (preferably a monoammonium or diammonium salt) and metal salts of EDTA or of EDTA acid. Preferred metal salts are dimetal or tetrametal salts, while preferred metals of these salts are selected from the group consisting of Group I and Group II metals. The most preferred Group I and Group II metals are selected from the group consisting of sodium (e.g., disodium, tetrasodium), lithium, calcium, potassium, and magnesium.

In certain embodiments, the nutrient source comprises respective sources of cobalt, nickel, zinc, and phosphorus. The cobalt source is preferably selected from the group consisting of chelated cobalt, cobalt sulfate, and mixtures thereof. The nickel source is preferably selected from the group consisting of chelated nickel, nickel oxide, nickel sulfates, nickel chloride, and mixtures thereof. Preferred sources of zinc include those selected from the group consisting of chelated zinc, zinc oxide, zinc sulfates (e.g., zinc sulfate monohydrate), zinc hydroxide carbonate, zinc chloride, and mixtures thereof. The phosphorus source is preferably selected from the group consisting of monoammonium phosphate, diammonium phosphate, monopotassium phosphate, rock phosphate, and mixtures thereof.

The compositions may also include an additional insecticide, for example, a reduced risk pesticide as classified by the Environmental Protective Agency. Reduced risk pesticides include pesticides with characteristics such as very low toxicity to humans and non-target organisms, including fish and birds, low risk of ground water contamination or runoff, and low potential for pesticide resistance. Exemplary active ingredients for reduced risk pesticides include but are not limited to, castor oil, cedar oil, cinnamon and cinnamon oil, citric acid, citronella and citronella oil, cloves and clove oil, corn gluten meal, corn oil, cottonseed oil, dried blood, eugenol, garlic and garlic oil, geraniol, geranium oil, lauryl sulfate, lemon grass oil, linseed oil, malic acid, mint and mint oil, peppermint and peppermint oil, 2-phenethyl propionate (2-phenyethyl propionate), potassium sorbate, putrescent whole egg solids, rosemary and rosemary oil, sesame and sesame oil, sodium chloride, sodium lauryl sulfate, soybean oil, thyme and thyme oil, white pepper, zinc metal strips, and combinations thereof.

The compositions may also optionally include humectants such as glycerol to slow evaporation and maintain wetness of the composition after application. When a humectant is included in the compositions, the humectant may constitute between about 0.5% and about 10% by weight of the composition.

In certain embodiments, the compositions may comprise, or the methods may employ, either within the formulation or in a formulation separate from the composition, a classical repellant, a toxicant, or insect growth regulators (e.g., growth inhibitors).

Additional components may include, but are not limited to, pesticides, insecticides, herbicides, fungicides, nematicides, acaricides, bactericides, miticides, algicides, germicides, nutrients, and combinations thereof. Specific examples of insecticides include, but are not limited to, a botanical, a carbamate, a microbial, a dithiocarbamate, an imidazolinone, an organophosphate, an organochlorine, a benzoylurea, an oxadiazine, a spinosyn, a triazine, a carboxamide, a tetronic acid derivative, a triazolinone, a neonicotinoid, a pyrethroid, a pyrethrin, and a combination thereof. Specific examples of herbicides include, without limitation, a urea, a sulfonyl urea, a phenylurea, a pyrazole, a dinitroaniline, a benzoic acid, an amide, a diphenylether, an imidazole, an aminotriazole, a pyridazine, an amide, a sulfonamide, a uracil, a benzothiadiazinone, a phenol, and a combination thereof. Specific examples of fungicides include, without limitation, a dithiocarbamate, a phenylamide, a benzimidazole, a substituted benzene, a strobilurin, a carboxamide, a hydroxypyrimidine, an anilopyrimidine, a phenylpyrrole, a sterol demethylation inhibitor, a triazole, and a combination thereof. Specific examples of acaricides or miticides include, without limitation, rosemary oil, thymol, spirodiclogen, cyflumetofen, pyridaben, diafenthiuron, etoxazole, spirodiclofen, acequinocyl, bifenazate, and a combination thereof.

Other optional features of the composition include carriers that protect the insect repellant composition against UV and/or acidic conditions. In certain embodiments, the composition contains a pH buffer. In certain embodiments, the composition is formulated to have a pH in the range of about 4.5 to about 9.0, including for example pH ranges of about any one of 5.0 to about 8.0, about 6.5 to about 7.5 or about 6.5 to about 7.0.

For further information on agricultural formulations, see “Chemistry and Technology of Agrochemical Formulations” edited by D. A. Knowles, copyright 1998 by Kluwer Academic Publishers. Also see “Insecticides in Agriculture and Environment-Retrospects and Prospects” by A. S. Perry, I. Yamamoto, I. Ishaaya, and R. Perry, copyright 1998 by Springer-Verlag.

### Method of Use

The insect repellent compositions described herein are useful in a variety of agricultural methods, particularly for the prevention or reduction of infestations by herbivorous insect pests. The disclosure provides methods of repelling at least one insect pest from a target recipient plant or field of plants. The methods may comprise applying a composition of the disclosure to the target. As used herein, “target” is a plant surface, crop production site, or other areas where the insects are not desired.

In certain embodiments, the present methods involve delivering the insect repellant compositions described herein to a plant or an insect pest, such as those described included herein. The methods of the disclosure may be carried out by applying insect repellant compositions as described herein to a target surface or site to which insect pests are attracted. In some embodiments, the applying step is carried out by applying the repellant composition or utilizing repellent compounds as described herein.

For example, such an insect repellent effect may be characterized by a decrease in the propensity of a sample of insects to feed upon a plant source or crop as affected by the presence of the substance(s) having that effect. Such a decrease may be qualitative (e.g., an observation of a general change in insect behavior) or, in particular, may be quantitative (i.e., measurable) such as a reduction in the amount of plant damage due to feeding insects. In such circumstances, such an effect may be characterized by at least a 10% (e.g., at least a 20%, such as at least a 30% or, particularly at least a 50% or, more particularly, at least a 100%) decrease in the propensity of a sample of insects or crop damage amounts. Alternatively, the skilled person will be aware of various means by which such effects may be assessed (e.g., measured) by experiments performed in a controlled setting, such as may be described in more detail herein. For example, such experiments may assess the increased bias of insects to travel away and/or land upon the plants to which the compositions have been applied, such an effect may be characterized by at least a 10% (e.g., at least a 20%, such as at least a 30% or, particularly at least a 50%) decrease in said bias.

The compositions and related methods can be used to prevent infestation by or reduce the numbers of insect pests on plants, plant parts (e.g., roots, fruits and seeds), in or on soil, or on another plant medium. Accordingly, the compositions and methods can reduce the damaging effect of insect pests on a plant by, for example, repelling the insect or reducing fecundity of the insect, and can thereby increase the fitness of a plant. Insect repellent compositions of the disclosure can be used to repel one or more of any of these insects in any developmental stage, e.g., their egg, nymph, instar, larvae, adult, juvenile, or desiccated forms.

Provided herein are methods of delivering to a plant an insect repellant composition disclosed herein. Included are methods for delivering an insect repellent composition to a plant by contacting the plant, or part thereof, with an insect repellant composition. The methods can be useful for increasing the fitness of a plant, e.g., by treating or preventing an insect pest infestation.

As such, the methods can be used to increase the fitness of a plant. In certain embodiments, provided herein is a method of increasing the fitness of a plant, the method including delivering to the plant the insect repellant composition described herein (e.g., in an effective amount and duration) to increase the fitness of the plant relative to an untreated plant (e.g., a plant that has not been delivered the insect repellent composition).

An increase in the fitness of the plant as a consequence of delivery of an insect repellant composition can manifest in a number of ways, e.g., thereby resulting in a better production of the plant, for example, an improved yield, improved vigor of the plant or quality of the harvested product from the plant. An improved yield of a plant relates to an increase in the yield of a product (e.g., as measured by plant biomass, grain, seed or fruit yield, protein content, carbohydrate or oil content or leaf area) of the plant by a measurable amount over the yield of the same product of the plant produced under the same conditions, but without the application of the instant compositions or compared with application of conventional pesticides. For example, yield can be increased by at least about 0.5%, about 1%, about 2%, about 3%, about 4%, about 5%, about 10%, about 20%, about 30%, about 40%, about 50%, about 60%, about 70%, about 80%, about 90%, about 100%, or more than 100%. Yield can be expressed in terms of an amount by weight or volume of the plant or a product of the plant on some basis. The basis can be expressed in terms of time, growing area, weight of plants produced, or amount of a raw material used. For example, such methods may increase the yield of plant tissues including, but not limited to seeds, fruits, kernels, bolls, tubers, roots, and leaves.

An increase in the fitness of a plant as a consequence of delivery of an insect repellant composition can also be measured by other means, such as an increase or improvement of the vigor rating, the stand (the number of plants per unit of area), plant height, stalk circumference, stalk length, leaf number, leaf size, plant canopy, visual appearance (such as greener leaf color), root rating, emergence, protein content, increased tillering, bigger leaves, more leaves, less dead basal leaves, stronger tillers, less fertilizer needed, less seeds needed, more productive tillers, earlier flowering, early grain or seed maturity, less plant verse (lodging), increased shoot growth, earlier germination, or any combination of these factors, by a measurable or noticeable amount over the same factor of the plant produced under the same conditions, but without the administration of the insect repellent compositions of the disclosure or with application of conventional pesticides.

Included herein is a method of decreasing an insect pest infestation in a plant having an infestation, wherein the method includes delivering the insect repellent composition to the plant (e.g., in an effective amount and for an effective duration) to decrease the infestation relative to the infestation in an untreated plant. For example, the method may be effective to decrease the infestation by about 1%, 2%, 5%, 10%, 20%, 30%, 40%, 50%, 60%, 70%, 80%, 90%, 95%, 99%, 100%, or more than 100% relative to an untreated plant. In certain embodiments, the method is effective to decrease the infestation by about 2×-fold, 5×-fold, 10×-fold, 25×-fold, 50×-fold, 75×-fold, 100×-fold, or more than 100×-fold relative to an untreated plant. In certain embodiments, the method substantially eliminates the infestation relative to the infestation in an untreated plant. Alternatively, the method may slow progression of an infestation or decrease the severity of symptoms associated with an infestation. The composition may be sufficient to reduce (e.g., repel) the insect pest, e.g., at least 5%, 10%, 20%, 30%, 40%, 50%, 60%, 70%, 80% or more, compared to a control.

The insect repellent compositions described herein may be useful to promote the growth of plants. For example, by reducing the presence of harmful insect pests, the insect repellant compositions provided herein may be effective to promote the growth of plants that are typically harmed by an insect pest. This may or may not involve direct application of the insect repellant composition to the plant. For example, in embodiments where the primary pest habitat is different than the region of plant growth, the insect repellant composition may be applied to either the primary pest habitat, the plants of interest, or a combination of both.

In certain embodiments, the plant may be an agricultural food crop, such as a cereal, grain, legume, fruit, or vegetable crop, or a non-food crop, e.g., grasses, flowering plants, cotton, hay, hemp. The compositions described herein may be delivered to the crop any time prior to or after harvesting the cereal, grain, legume, fruit, vegetable, or other crop. Crop yield is a measurement often used for crop plants and is normally measured in metric tons per hectare (or kilograms per hectare). Crop yield can also refer to the actual seed generation from the plant. In certain embodiments, the insect repellent composition may be effective to increase crop yield (e.g., increase metric tons of cereal, grain, legume, fruit, or vegetable per hectare and/or increase seed generation) by about 2%, 5%, 10%, 20%, 30%, 40%, 50%, 60%, 70%, 80%, 90%, 100%, or more in comparison to a reference level (e.g., a crop to which the insect repellent composition has not been administered).

A decrease in infestation refers to a decrease in the number of insect pests on or around the plant or a decrease in symptoms or signs in the plant that are directly or indirectly caused by the insect pest. The degree of infestation may be measured in the plant at any time after treatment and compared to symptoms at or before the time of treatment. The plant may or may not be showing symptoms of the infestation. For example, the plant may be infested with an insect pest yet not showing signs of the infestation. An infested plant can be identified through observation of symptoms on the plant. The symptoms expressed will depend on the pest, but in general the symptoms include chewed leaves, discoloration, sticky residue, stunted growth, wilted appearance, and the like.

The skilled artisan will recognize that methods for determining plant infestation by an insect pest depends on the insect and plant being tested. Infestation or associated symptoms can be identified by any means of identifying infestation or related symptoms. Various methods are available to identify infested plants and the associated symptoms. In one aspect, the methods may involve macroscopic or microscopic screening for infestation in a plant. Macroscopic and microscopic methods for determining infestation in a plant are known in the art and include the identification of damage on plant tissue caused by infestation.

The plant can be pre-determined to have an insect pest infestation. Alternatively, the method may also include identifying plants having an infestation. As such, also provided are methods of treating an insect pest infestation by identifying a plant infested by an insect pest (i.e. post-infestation) and contacting the infected plant with an effective amount of an insect repellant composition such that the infestation is treated. Infestation can be measured by any reproducible means of measurement. For example, infestation can be measured by measuring the concentration of insect pests over a provided area of the plant or an area surrounding the plant.

Included herein is a method of preventing an insect pest infestation in a plant (e.g., a plant at risk of infestation), wherein the method includes delivering the insect repellant composition to the plant (e.g., in an effective amount and duration) to decrease the likelihood of infestation relative to the likelihood of infestation in an untreated plant. For example, the method can decrease the likelihood of infestation by about 1%, 2%, 5%, 10%, 20%, 30%, 40%, 50%, 60%, 70%, 80%, 90%, 95%, 99%, 100%, or more than 100% relative to an untreated plant. In certain embodiments, the method can decrease the likelihood of infestation by about 2×-fold, 5×-fold, 10×-fold, 25×-fold, 50×-fold, 75×-fold, 100×-fold, or more than 100×-fold relative to an untreated plant.

The methods and compositions described herein may be used to reduce or prevent insect pest infestation in plants at risk of developing an infestation by reducing the fitness of insects that infest the plants. In certain embodiments, the insect repellent composition may be effective to reduce infestation (e.g., reduce the number of plants infested, reduce the insect pest population size, reduce damage to plants) by about 2%, 5%, 10%, 20%, 30%, 40%, 50%, 60%, 70%, 80%, 90%, 100%, or more in comparison to a reference level (e.g., a crop to which the insect repellent composition has not been administered). In other embodiments, the insect repellant composition may be effective to prevent or reduce the likelihood of crop infestation by about 2%, 5%, 10%, 20%, 30%, 40%, 50%, 60%, 70%, 80%, 90%, 100%, or more in comparison to a reference level (e.g., a crop to which the insect repellant composition has not been administered).

These preventive methods can be useful to prevent infestation in a plant at risk of being infested by an insect pest. For example, the plant may be one that has not been exposed to an insect pest, but the plant may be at risk of infection in circumstances where insect pests are more likely to infest the plant, for example, in optimal climate conditions for the insect. In certain embodiments, identifying a crop plant in need of treatment is by prediction of weather and environmental conditions conducive for development of an infestation.

The methods may prevent infestation for a period of time after treatment with the insect repellant composition. For example, the method may prevent infestation of the plant for several weeks after application of the insect repellant composition. For instance, the infestation may be prevented for at least about 14, 15, 16, 17, 18, 19, 20, 21, 22, 23, 24, 25, 26, 27, 28, 29, 30, 35 days after treatment with an insect repellent composition. Prevention of an infestation may be measured by any reproducible means of measurement. In certain embodiments, infestation is assessed 7, 8, 9, 10, 11, 12, 13, 14, 15, 16, 17, 18, 19, 20, 25, 30 days after delivery of the insect repellant composition.

Provided herein are methods of delivering to an insect pest an insect repellant composition disclosed herein. Included are methods for delivering an insect repellant composition to an insect pest by contacting the insect pest with an insect repellent composition. In certain embodiments, the methods can be useful for decreasing the fitness of an insect pest, e.g., to prevent or treat an insect pest infestation as a consequence of delivery of an insect repellant composition.

As such, the methods can be used to decrease the fitness of an insect pest. In one aspect, provided herein is a method of decreasing the fitness of an insect pest, the method including delivering to the insect pest the insect repellant composition described herein (e.g., in an effective amount and for an effective duration) to decrease the fitness of the insect pest relative to an untreated insect pest (e.g., an insect pest that has not been delivered the insect repellant composition).

A decrease in the fitness of the insect pest as a consequence of delivery of an insect repellant composition can manifest in a number of ways. In certain embodiments, the fitness of an insect may be measured by one or more parameters, including, but not limited to, reproductive rate, fertility, lifespan, viability, mobility, fecundity, insect development, body weight, metabolic rate or activity, or survival in comparison to an insect to which the insect repellant composition has not been administered. For example, the methods or compositions provided herein may be effective to decrease the overall health of the insect pest or to decrease the overall survival of the insect pest. In certain embodiments, the methods and compositions are effective to decrease insect pest reproduction (e.g., fecundity) in comparison to an insect to which the insect repellent composition has not been administered. In certain embodiments, the methods and compositions are effective to decrease insect pest reproduction by about 2%, 5%, 10%, 20%, 30%, 40%, 50%, 60%, 70%, 80%, 90%, 100%, or greater than 100% relative to a reference level (e.g., a level found in an insect that does not receive an insect repellant composition). Insect fitness may be evaluated using any standard methods in the art. In certain embodiments, insect fitness may be evaluated by assessing an individual insect. Alternatively, insect fitness may be evaluated by assessing an insect population.

An insect described herein can be exposed to any of the insect repellent compositions described herein in any suitable manner that permits delivering or administering the composition to the insect. The insect repellant composition may be delivered either alone or in combination with other active (e.g., pesticidal agents) or inactive substances and may be applied by, for example, spraying, injection (e.g., microinjection), through plants, pouring, dipping, in the form of concentrated liquids, gels, solutions, suspensions, sprays, powders, pellets, briquettes, bricks and the like, formulated to deliver an effective concentration of the insect repellent composition. Amounts and locations for application of the compositions described herein are generally determined by the habits of the insect, the lifecycle stage at which the insect can be targeted by the insect repellent composition, the site where the application is to be made, and the physical and functional characteristics of the insect repellant composition.

In certain embodiments, the composition is sprayed directly onto a plant e.g., crops, by e.g., backpack spraying, aerial spraying, crop spraying/dusting etc. In embodiments where the insect repellant composition is delivered to a plant, the plant receiving the insect repellant composition may be at any stage of plant growth. For example, formulated insect repellent compositions can be applied as a seed-coating or root treatment in early stages of plant growth or as a total plant treatment at later stages of the crop cycle. In certain embodiments, the insect repellant composition may be applied as a topical agent to a plant, such that the insect comes in contact with the composition upon interacting with the plant. Further, the insect repellant composition may be applied in the soil in which a plant grows, or in the water that is used to water the plant.

Delayed or continuous release can also be accomplished by coating the insect repellant composition or a composition with the insect repellant composition(s) with a dissolvable or bioerodable coating layer, such as gelatin, which coating dissolves or erodes in the environment of use, to then make the insect repellant composition available, or by dispersing the agent in a dissolvable or erodable matrix. Such continuous release and/or dispensing means devices may be advantageously employed to consistently maintain an effective concentration of one or more of the insect repellant compositions described herein in a specific insect habitat.

Pesticides are often recommended for field application as an amount of pesticide per hectare (g/ha or kg/ha) or the amount of active ingredient or acid equivalent per hectare (kg a.i./ha or g a.i./ha). In certain embodiments, a lower amount of pesticide in the present compositions may be required to be applied to soil, plant media, seeds plant tissue, or plants to achieve the same results as where the pesticide is applied in a composition lacking the semiochemicals of the present disclosure. For example, the amount of pesticidal agent may be applied at levels about 2, 3, 4, 5, 6, 7, 8, 9, 10, 15, 20, 30, 50, or 100-fold (or any range between about 2 and about 100-fold, for example about 2- to 10-fold; about 5- to 15-fold, about 10- to 20-fold; about 10- to 50-fold) less than the same pesticidal agent applied in a control composition, e.g., direct application of the same pesticidal agent. Insect repellent compositions of the disclosure can be applied at a variety of amounts per hectare, for example at about 0.0001, 0.001, 0.005, 0.01, 0.1, 1, 2, 10, 100, 1,000, 2,000, 5,000 (or any range between about 0.0001 and 5,000) kg/ha. For example, about 0.0001 to about 0.01, about 0.01 to about 10, about 10 to about 1,000, about 1,000 to about 5,000 kg/ha.

### Plants

A variety of plants can be treated with an insect repellent composition described herein. Plants that can be treated with an insect repellent composition in accordance with the present methods include whole plants and parts thereof, including, but not limited to, shoot vegetative organs/structures (e.g., leaves, stems and tubers), roots, flowers and floral organs/structures (e.g., bracts, sepals, petals, stamens, carpels, anthers and ovules), seed (including embryo, endosperm, cotyledons, and seed coat) and fruit (the mature ovary), plant tissue (e.g., vascular tissue, ground tissue, and the like) and cells (e.g., guard cells, egg cells, and the like), and progeny of same. Plant parts can further refer parts of the plant such as the shoot, root, stem, seeds, stipules, leaves, petals, flowers, ovules, bracts, branches, petioles, internodes, bark, pubescence, tillers, rhizomes, fronds, blades, pollen, stamen, and the like.

The class of plants that can be treated in a method disclosed herein includes the class of higher and lower plants, including angiosperms (monocotyledonous and dicotyledonous plants), gymnosperms, ferns, horsetails, psilophytes, lycophytes, bryophytes, and algae (e.g., multicellular or unicellular algae). Plants that can be treated in accordance with the present methods further include any vascular plant, for example monocotyledons or dicotyledons or gymnosperms, including, but not limited to alfalfa, apple, Arabidopsis, banana, barley, canola, castor bean, chrysanthemum, clover, cocoa, coffee, cotton, cottonseed, corn, Crambe, cranberry, cucumber, dendrobium, Dioscorea, eucalyptus, fescue, flax, Gladiolus, linseed, millet, muskmelon, mustard, oat, oil palm, oilseed rape, Papaya, peanut, pineapple, ornamental plants, Phaseolus, potato, rapeseed, rice, rye, ryegrass, safflower, sesame, sorghum, soybean, sugar beet, sugarcane, sunflower, strawberry, tobacco, tomato, turfgrass, and wheat; vegetable crops such as lettuce, celery, broccoli, cauliflower, cucurbits; fruit and nut trees such as apple, pear, peach, orange, grapefruit, lemon, lime, almond, pecan, walnut, hazel; vines such as grapes (e.g., a vineyard), kiwi, hops; fruit shrubs and brambles such as raspberry, blackberry, and gooseberry; forest trees, such as ash, pine, fir, maple, oak, chestnut, and poplar.

Plants that can be treated in accordance with the methods of the present disclosure include any crop plant, for example, forage crop, oilseed crop, grain crop, fruit crop, vegetable crop, fiber crop, spice crop, nut crop, turf crop, sugar crop, beverage crop, and forest crop. Examples of such crop plants include, but are not limited to, monocotyledonous and dicotyledonous plants including, but not limited to, fodder or forage legumes, ornamental plants, food crops, trees, or shrubs selected from Acer spp., Allium spp., Amaranthus spp., Ananas comosus, Apium graveolens, Arachis spp, Asparagus officinalis, Beta vulgaris, Brassica spp. (e.g., Brassica napus, Brassica oleracea, Brassica rapa (canola, oilseed rape, turnip rape), Camellia sinensis, Canna indica, Cannabis saliva, Capsicum spp., Castanea spp., Cichorium endivia, Citrullus lanatus, Citrus spp., Cocos spp., Coffea spp., Coriandrum sativum, Corylus spp., Crataegus spp., Cucurbita spp., Cucumis spp., Daucus carota, Fagus spp., Ficus carica, Fragaria spp., Ginkgo biloba, Glycine spp. (e.g., Glycine max), Gossypium hirsutum, Helianthus spp. (e.g., Helianthus annuus), Hibiscus spp., Hordeum spp. (e.g., Hordeum vulgare), Ipomoea batatas, Juglans spp., Lactuca sativa, Linum usitatissimum, Litchi chinensis, Lotus spp., Luffa acutangula, Lupinus spp., Lycopersicon spp., Malus spp., Medicago sativa, Mentha spp., Miscanthus sinensis, Morus nigra, Musa spp., Nicotiana spp., Olea spp., Oryza spp. (e.g., Oryza sativa, Oryza latifolia), Panicum miliaceum, Panicum virgatum, Passiflora edulis, Petroselinum crispum, Phaseolus spp., Pinus spp., Pistacia vera, Pisum spp., Poa spp., Populus spp., Prunus spp., Pyrus communis, Quercus spp., Raphanus sativus, Rheum rhabarbarum, Ribes spp., Ricinus communis, Rubus spp., Saccharum spp., Salix sp., Sambucus spp., Secale cereale, Sesamum spp., Sinapis spp., Solanum spp. (e.g., Solanum tuberosum, Solanum integrifolium or Solanum lycopersicum), Sorghum bicolor, Sorghum halepense, Spinacia spp., Tamarindus indica, Theobroma cacao, Trifolium spp., Triticosecale rimpaui, Triticum spp. (e.g., Triticum aestivum, Triticum durum, Triticum turgidum, Triticum hybernum, Triticum macha, Triticum sativum or Triticum vulgare), Vaccinium spp., Vicia spp., Vigna spp., Viola odorata, Vitis spp., and Zea mays. In certain embodiments, the crop plant is rice, oilseed rape, canola, soybean, corn (maize), cotton, sugarcane, alfalfa, sorghum, or wheat.

The plant or plant part for use in the present disclosure include plants of any stage of plant development. In certain embodiments, the delivery can occur during the stages of germination, seedling growth, vegetative growth, and reproductive growth. In certain embodiments, delivery to the plant occurs during vegetative and reproductive growth stages. Alternatively, the delivery can occur to a seed. The stages of vegetative and reproductive growth are also referred to herein as “adult” or “mature” plants.

### Herbivorous Insect Pests

The insect repellant compositions and related methods described herein are useful to repel herbivorous insect pests or otherwise decrease the fitness of herbivorous insect pests and thereby treat or prevent infestations of the same in plants. Examples of insects that can be treated with the present compositions or related methods are further described herein.

In certain embodiments, the insect is from the order Hemiptera (aphid, scale, whitefly, leafhopper), for example, Acrythosiphon pisum (pea aphid), Adelges spp. (Adelgids), Aleyrodes proletella (cabbage whitefly), Aleurodicus disperses (spiralling whitefly), Aleurothrixus flccosus (woolly whitefly), Aulacaspis spp. (scales), Amrasca biguttula (cotton jassid), Aphrophora spp. (leafhoppers), Aonidiella aurantii (California red scale), Aphis spp. (aphids), Aphis gossypii (cotton aphid), Aphis pomi (apple aphid), Aulacorthum solani (foxglove aphid), Bemisia spp. (whiteflies), Bemisia argentifolii, Bemisia tabaci (sweetpotato whitefly), Brachycolus noxius (Russian aphid), Brachycorynella asparagi (asparagus aphid), Brevennia rehi, Brevicoryne brassicae (cabbage aphid), Ceroplastes spp. (scales), Ceroplastes rubens (red wax scale), Chionaspis spp. (scales), Chrysomphalus spp. (scales), Coccus spp. (scales), Dysaphis plantaginea (rosy apple aphid), Empoasca spp. (leafhoppers), Eriosoma lanigerum (woolly apple aphid), Icerya purchasi (cottony cushion scale), Idioscopus nitidulus (mango leafhopper), Laodelphax striatellus (smaller brown planthopper), Lepidosaphes spp., Macrosiphum spp., Macrosiphum euphorbiae (potato aphid), Macrosiphum granarium (English grain aphid), Macrosiphum rosae (rose aphid), Macrosteles quadrilineatus (aster leafhopper), Mahanarva frimbiolata, Metopolophium dirhodum (rose grain aphid), Mictis longicornis, Myzus spp., Myzus persicae (green peach aphid), Nephotettix spp. (leafhoppers), Nephotettix cinctipes (green leafhopper), Nilaparvata lugens (brown planthopper), Parlatoria pergandii (chaff scale), Parlatoria ziziphi (ebony scale), Peregrinus maidis (corn delphacid), Philaenus spp. (spittlebugs), Phylloxera vitifoliae (grape phylloxera), Physokermes piceae (spruce bud scale), Planococcus spp. (mealybugs), Pseudococcus spp. (mealybugs), Pseudococcus brevipes (pine apple mealybug), Quadraspidiotus perniciosus (San Jose scale), Rhapalosiphum spp. (aphids), Rhapalosiphum maida (corn leaf aphid), Rhapalosiphum padi (oat bird-cherry aphid), Saissetia spp. (scales), Saissetia oleae (black scale), Schizaphis graminum (greenbug), Sitobion avenae (English grain aphid), Sogatella furcifera (white-backed planthopper), Therioaphis spp. (aphids), Toumeyella spp. (scales), Toxoptera spp. (aphids), Trialeurodes spp. (whiteflies), Trialeurodes vaporariorum (greenhouse whitefly), Trialeurodes abutiloneus (bandedwing whitefly), Unaspis spp. (scales), Unaspis yanonensis (arrowhead scale), or Zulia entreriana. In at least some embodiments, the composition and methods of the disclosure may be used to control aphids.

In certain embodiments, the insect is from the order Thysanoptera (thrips), for example, Anaphothrips obscurus, Baliothrips biformis (rice thrips), Drepanothrips reuteri (grape thrips), Enneothrips flavens, Frankliniella spp., Frankliniella fusca (tobacco thrips), Frankliniella occidentalis (western flower thrips), Frankliniella shultzei, Frankliniella williamsi (corn thrips), Heliothrips spp., Heliothrips haemorrhaidalis (greenhouse thrips), Hercinothrips femoralis, Rhipiphorothrips cruentatus, Scirtothrips spp., Scirtothrips citri (citrus thrips), Scirtothrips dorsalis (yellow tea thrips), Taeniothrips cardamomi, Taeniothrips rhopalantennalis, or Thrips spp.

In certain embodiments, the insect is a mite, including but not limited to, spider mites, such as Oligonychus shinkaji, Panonychus citri, Panonychus mori, Panonychus ulmi, Tetranychus kanzawai, Tetranychus urticae, or the like.

### Kits

The present disclosure also provides a kit for the control or prevention of insect pests, where the kit includes a container having an insect repellent composition described herein. The kit may further include instructional material for applying or delivering (e.g., to a plant or to an insect pest) the insect repellant composition to control, prevent, or treat an insect pest infestation in accordance with a method of the present disclosure. The skilled artisan will appreciate that the instructions for applying the insect repellant composition in the methods of the present disclosure can be any form of instruction. Such instructions include, but are not limited to, written instruction material (such as, a label, a booklet, a pamphlet), oral instructional material (such as on an audio cassette or CD) or video instructions (such as on a video tape or DVD).

### Embodiments

The following numbered embodiments also form part of the present disclosure:

1. An insect repellant composition that alters herbivorous insect behavior comprising: a semiochemical that is produced by an insect of the family Coccinellidae; and an agriculturally acceptable carrier.

2. The composition of embodiment 1, wherein the insect of the family Coccinellidae is Harmonia axyridis.

3. The composition of embodiment 1 or embodiment 2, wherein the composition comprises a methoxypyrazine.

4. The composition any one of embodiments 1-3, wherein the methoxypyrazine comprises 2-isopropyl-3-methoxypyrazine, 2-sec-butyl-3-methoxypyrazine, or 2-isobutyl-3-methoxypyrazine.

5. The composition of any one of embodiments 1-4, further comprising a terpene.

6. The composition of any one of embodiments 1-5, wherein the terpene comprises β-caryophyllene, α-humulene, limonene, or α-pinene.

7. The composition of any one of embodiments 1-6, wherein the composition comprises one or more of: 2-isopropyl-3-methoxypyrazine; 2-sec-butyl-3-methoxypyrazine; 2-isobutyl-3-methoxypyrazine; β-caryophyllene; α-humulene; limonene; α-pinene; octadecanoic acid; dimethyl sulfone; camphene; 1,2,4-trimethylbenzene; styrene; benzene acetic acid methyl ester; propylbenzene; 2-ethyl-1-hexanol; caprolactam; mesitylene; 2-heptanone; 2-octanone; 1-octanol; eicosane; tetracosane; indole; 3-methyl-1-butanol; decane; 1,4-diethylbenzene; dodecanoic acid; cyclopentadecane; indane; borneal; 2,3-butanediol; acetoin; o-cymene; tetrahydro-2H-pyran-2-one; 3-(methylthio)-1-propanol; terpinolene; 2,3,3-trimethyl-1-butene; pentadecane; heneicosane; docosane; pentacosane; hentriacotane; 2-nonanone; 1-ethyl-2,3-dimethylbenzene; dimethylsilanediol; 4-unadecanone; dehydromevalonic lactone; methyl ester octadeca-9,12-dienoate; geranyl acetone; (Z)-3,7-dimethyl-3,6-octadien-1-ol; 1,3,5-tris(trimethylsiloxy)benzene; 6-methyl-3,4-dihydro-2H-pyran; 5-butylnonane; 1-hexacosene; S-methyl 3-methylbutanethioate; 4-hydroxy 3-(methylamino)benzonitrile; camphene hydrate; 3,7 dimethyl-6-noen-1-ol acetate; 4-(3-hydroxy-2,2,6-trimethyl-7-oxa-bicyclo[4.1.0]hept-1-yl)-but-3-en-2-one; 2-hydrazino-4,6-dimethylpyrimidine, 2TMS derivative; 1-oodododecane.

8. The composition of any one of embodiments 1-7, wherein the herbivorous insect is a soft-bodied insect preyed upon by H. axyridis.

9. The composition of any one of embodiments 1-8, wherein the herbivorous insect is an aphid, scale, mealy bug, leaf hopper, or mite.

10. The composition of any one of embodiments 1-9, wherein the composition further comprises a surfactant, a thickening agent, a plant nutrient, or a preservative.

11. The composition of any one of embodiments 1-10, wherein the composition is formulated as a liquid, a solid, an aerosol, a paste, a gel, or a gas composition.

12. The composition of any one of embodiments 1-11, wherein the carrier is water.

13. The composition of any one of embodiments 1-12, wherein the carrier is a solid or semi-solid carrier.

14. The composition of any one of embodiments 1-13, wherein the solid or semi-solid carrier is a wax, wax-like, gel or gel like material; an absorbent solid material or material capable of having the composition adsorbed thereon; or a solid matrix capable of having the composition contained therein.

15. A method of repelling herbivorous insects from a plant, the method comprising: delivering to the plant or plant area an insect repellent composition comprising: a semiochemical that is produced by an insect of the family Coccinellidae; and an agriculturally acceptable carrier.

16. The method of embodiment 15, wherein the insect of the family Coccinellidae is Harmonia axyridis.

17. The method of embodiment 15 or embodiment 16, wherein the composition comprises a methoxypyrazine.

18. The method of any one of embodiments 15-17, wherein the methoxypyrazine comprises 2-isopropyl-3-methoxypyrazine, 2-sec-butyl-3-methoxypyrazine, or 2-isobutyl-3-methoxypyrazine.

19. The method of any one of embodiments 15-18, further comprising a terpene.

20. The method of any one of embodiments 15-19, wherein the terpene comprises β-caryophyllene, α-humulene, limonene, or α-pinene.

21. The method of any one of embodiments 15-20, wherein the composition comprises one or more of: 2-isopropyl-3-methoxypyrazine; 2-sec-butyl-3-methoxypyrazine; 2-isobutyl-3-methoxypyrazine; β-caryophyllene; α-humulene; limonene; α-pinene; octadecanoic acid; dimethyl sulfone; camphene; 1,2,4-trimethylbenzene; styrene; benzene acetic acid methyl ester; propylbenzene; 2-ethyl-1-hexanol; caprolactam; mesitylene; 2-heptanone; 2-octanone; 1-octanol; eicosane; tetracosane; indole; 3-methyl-1-butanol; decane; 1,4-diethylbenzene; dodecanoic acid; cyclopentadecane; indane; borneal; 2,3-butanediol; acetoin; o-cymene; tetrahydro-2H-pyran-2-one; 3-(methylthio)-1-propanol; terpinolene; 2,3,3-trimethyl-1-butene; pentadecane; heneicosane; docosane; pentacosane; hentriacotane; 2-nonanone; 1-ethyl-2,3-dimethylbenzene; dimethylsilanediol; 4-unadecanone; dehydromevalonic lactone; methyl ester octadeca-9,12-dienoate; geranyl acetone; (Z)-3,7-dimethyl-3,6-octadien-1-ol; 1,3,5-tris(trimethylsiloxy)benzene; 6-methyl-3,4-dihydro-2H-pyran; 5-butylnonane; 1-hexacosene; S-methyl 3-methylbutanethioate; 4-hydroxy 3-(methylamino)benzonitrile; camphene hydrate; 3,7 dimethyl-6-noen-1-ol acetate; 4-(3-hydroxy-2,2,6-trimethyl-7-oxa-bicyclo[4.1.0]hept-1-yl)-but-3-en-2-one; 2-hydrazino-4,6-dimethylpyrimidine, 2TMS derivative; 1-oodododecane.

22. The method of any one of embodiments 15-21, wherein the herbivorous insect is a soft-bodied insect preyed upon by H. axyridis.

23. The method of any one of embodiments 15-22, wherein the herbivorous insect is an aphid, scale, mealy bug, leaf hopper, or mite.

24. The method of any one of embodiments 15-23, wherein the composition further comprises a surfactant, a thickening agent, a plant nutrient, or a preservative.

25. The method of any one of embodiments 15-24, wherein the composition is formulated as a liquid, a solid, an aerosol, a paste, a gel, or a gas composition.

26. The method of any one of embodiments 15-25, wherein the carrier is water.

27. The method of any one of embodiments 15-26, wherein the carrier is a solid or semi-solid carrier.

28. The method of any one of embodiments 15-27, wherein the solid or semi-solid carrier is a wax, wax-like, gel or gel like material; an absorbent solid material or material capable of having the composition adsorbed thereon; or a solid matrix capable of having the composition contained therein.

29. The method of any one of embodiments 15-28, wherein the delivering is by spraying.

All publications and patent applications mentioned in the specification are indicative of the level of skill of those skilled in the art to which this disclosure pertains. All publications and patent applications are herein incorporated by reference to the same extent as if each individual publication or patent application was specifically and individually indicated to be incorporated by reference.

Although the foregoing disclosure has been described in some detail by way of illustration and example for purposes of clarity of understanding, it will be obvious that certain changes and modifications may be practiced within the scope of the appended embodiments. The following examples are offered by way of illustration and not by way of limitation.

### Examples

Predator-prey interactions are significant drivers of population dynamics within animal communities. Traditionally, how predators influence prey populations via their consumptive capacity is considered, but predators also affect prey populations by triggering changes in prey behavior and physiology through non-consumptive effects or predation risk effects. Predation risk detection and response contribute significantly to the co-evolutionary arms race between predators and their prey, making non-consumptive effects a critical element of predator-prey interactions. It has been argued that the impact of predation risk on prey demographics could be at least as strong as direct consumption or even stronger when considering cascading effects on prey resources, such as plants. Reduced prey density occurs when risk-induced trait changes, initiated by prey to avoid predation, come at the cost of reduced growth rate. Determining how prey detect their predators and which subsequent changes in traits occur that contribute to reductions in prey populations is essential for our holistic understanding of the impact of predators on prey-beyond consumptive effects. This understanding would justify exploring the exploitation of isolated cues used by herbivorous animals to identify predation risk, which could relieve herbivore pressure on primary producers.

Several stimuli are used by prey to assess predation risk, including tactile, visual, and olfactory cues associated with the predator. In particular, volatile odors are a major method of communication for insects, used between conspecifics to share the location of rich food sources, to outline territories, to warn conspecifics of danger, or by plants to call in predatory insects for protection. With such a refined communication system, it is reasonable that insects also use interspecific odor cues to detect predation risk. While there is evidence that a myriad of prey trait changes occur in response to predator non-consumptive effects, few studies specifically isolate predator odor cues as a factor influencing the response to predation risk.

Aphids and lady beetles are abundant prey and predator taxa within agricultural landscapes. Aphids are significant pests of agricultural commodities worldwide due to their parthenogenic reproduction and ability to transmit plant pathogens. Aphids also produce winged morphs as a means to disperse when conditions are poor on host plants, contributing to their successful spread across landscapes. Lady beetles are impressive consumers of aphids and are often relied upon as biological control agents in agricultural settings to subdue aphid populations. Due to this role in aphid pest management, the consumptive capacity of lady beetles on aphids is a well-studied model system in insect ecology. Likely due to this strong predator-prey relationship, lady beetles have been found to elicit significant non-consumptive effects on aphids, often linked to chemical cues left on plants by past natural enemy activity, and notably by the volatile odors emitted by the lady beetles. Since aphid management continues to be a global issue, understanding how to maximize the impact of their predators could aid in their control. Therefore, if the mechanism that aphids are using to identify risk by lady beetles is understood and isolated, it may be possible take advantage of this route of communication to elicit trait changes that benefit plant productivity. To approach this, how prey traits change in response to particular predator cues and elucidate their ultimate impact on the performance of prey populations must first be understood—an area that has rarely been explored.

### Example 1: Predator Cues Influence Aphid Host Preference

To assess host plant preference and colonization in the greenhouse, a pair of collard plants, one that was predator-free and one that had 2 H. axyridis bagged to a leaflet, were placed in mesh cube cages. Twenty adult aphids were released at the center of the cage and the total number of aphids on each treatment plant were assessed after 24 (n=30 replicates). Significantly more aphids selected the predator-free collard host plant after 24 hours, (p=0.00239). Next, whether H. axyridis chemical cues were responsible for this apparent avoidance was investigated in a laboratory choice test that enabled the isolation and testing of chemical odor cues only. Using a y-tube olfactometer, M. persicae were simultaneously exposed to two separate odor sources; a collard host plant that harbored H. axyridis and a collard host plant that was free of H. axyridis. 66% oriented toward the control, predator-free plant, suggesting that chemical cues play a large role in detection of predation risk.

To investigate host plant colonization in the open field, collard plants were placed >10 m apart in a crop field with one of two treatments: control (predator-free) and predation risk (5 H. axyridis bagged to a leaflet). Four collard host plants were then placed surrounding the treatment collard and aphid colonization was assessed after 3 days. Similar to the lab and greenhouse studies, colonizing aphids preferred to settle on collard plants that did not have predator cues compared to plots that had H. axyridis bagged to a leaf leading to a 35% reduction in aphids in plots with the predator treatment.

### Example 2: Predator Cues Influence Aphid Fecundity

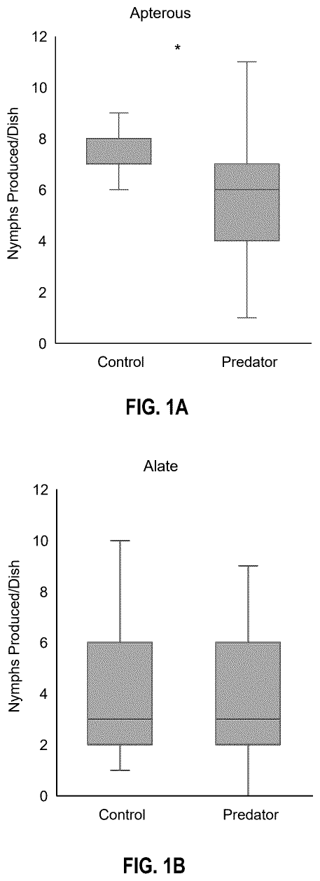

In addition to host seeking and host choice behaviors, there are a variety of other traits that can change in response to predation risk and predator cues. This is of utmost importance to understand since predator cues do not lead to a complete avoidance by the aphids. Once on a host, whether H. axyridis cues have an impact on aphid reproductive potential was investigated—a trait that sets the stage for their exponential growth and damage throughout a cropping season. To do this, five aphids were placed on leaf discs in modified petri dishes. The modified petri dishes enable the exposure of aphids to H. axyridis cues (or a predator-free control), without allowing them to physically interact, thereby eliminating the consumptive effect. Here, aphids produced 23% fewer offspring over 3 days suggesting that there is a shift in reproductive potential that leads to fewer offspring in the presence of predator cues (Z=−4.08, p<0.0001, FIG. 1A). In addition, a 5-fold increase in alate formation in offspring of predator cue-exposed apterous mothers was found in an addition leaf disc experiment indicating a long-lasting influence of predator cues on aphid colonies and an investment in dispersal (p=0.039, FIG. 1B).

### Example 3: Lady Beetle Odors Affect Aphid Population Abundance and Feeding, but not Movement Between Plants

In this Example, how Harmonia axyridis (multi-colored Asian lady beetle) odor cues affect three critical behaviors that contribute to aphid success and their status as agricultural pests: feeding behavior, movement within and between plants, and ultimately population abundance of Myzus persicae (green peach aphid) on Brassica oleracea (collard plants) were addressed. H. axyridis was focused on in this study due to their abundance and ubiquity in agroecosystems and to build off of prior work documenting that H. axyridis odor cues reduce individual traits of M. persicae including: reduced fecundity, altered host plant preference, and increased production of winged aphid morphs (Examples 1 and 2). This research investigated how predation risk influences M. persicae-H. axyridis interactions by assessing whether prolonged settling time, movement, and reduced feeding behavior could explain the reduced fecundity previously documented, and whether these responses scale up to influence M. persicae population abundance. To our knowledge, this is one of the first studies to use the electrical penetration graph technique to investigate how predation risk influences aphid feeding. Additionally, whether aphid wing presence contributes to the dispersal strategies of M. persicae away from H. axyridis odor cues was investigated to further explore the adaptive advantage of wing production in aphids.

### Insect Rearing and Predator Cue Isolation

A clonal colony of M. persicae reared on Brassica oleracea (cv. Georgia collard greens) in an insect-rearing growth chamber (24° C.; 16:8 L:D photoperiod) was used in experiments. Plants within the aphid colony were watered ad libitum, and older plants were replaced with fresh collard plants as needed to prevent aphid overcrowding. The colony of Harmonia axyridis was maintained year-round in an insect-rearing growth chamber (23° C.; 16:8 L:D photoperiod) and augmented with wild individuals each spring and fall. H. axyridis are fed corn leaf aphids, (Rhopalosiphum maidis Fitch) reared on barley (Hordeum vulgare). Only adult H. axyridis were used in the experiments, but age was not standardized across experiments.

Within all experiments, H. axyridis were caged within opaque metal mesh tea infusers (11.98 cm×2.99 cm×2.36 cm, Siasky Tea Strainer) and placed on the soil surface of the pot without touching the plant stem or leaves. In this setup, visual cues are minimized due to the opaque mesh, and vibrational cues were restricted by not allowing the tea infuser to make contact with the plant. This design, while attempting to eliminate as many confounding cues as possible, could allow for potential sound cues to be detected by the aphid. However, since M. persicae has been shown to respond to isolated H. axyridis odor cues in setups such as y-tube olfactometers, the majority response of the aphids in this study is likely due to odor responses. H. axyridis were caged in mixed-sex pairs to account for differences in the volatile profiles of the male and female beetles, except for the fourth experiment where the sex of the third beetle was randomized across treatments. The beetles were not isolated from one another, so mating may have occurred. Between experiments, the tea infusers were cleaned with Alconox detergent to ensure that any residual volatiles from previous experiments were removed.

### Predation Risk Influenced Aphid Feeding Behavior

The feeding behavior of M. persicae on B. oleracea in the presence of predator H. axyridis odors was assessed using an electrical penetration graph (EPG) system (DC-EPG, GIGA 8, EPG Systems, Wageningen, Netherlands). The DC-EPG system allows us to determine the feeding behaviors, such as cell punctures, phloem salivation, and phloem ingestion, by creating a circuit between the aphid and the plant on which it is feeding. The EPG assays were conducted in a lab setting (25° C., 49.2% humidity), and the plants were enclosed in a copper mesh Faraday cage (91.44 cm×67.05 cm×91.44 cm). Adult, wingless aphids were randomly chosen from the lab colony for observations and starved for 1 hour before wiring (methods from Nalam et al., 2018). A copper probe was created by soldering copper wire (18 gauge) to the end of a nail and affixing a fine gold wire (18 μm gold wire) around the end of the copper wire. Aphids were fastened to the end of the gold wire using silver glue (1:1:1 colloidal silver, paper glue, and water). Collard plants were placed inside the Faraday cage on top of non-conductive risers, and connected to the GIGA 8 system by placing copper electrodes in the soil at the base of each plant. The tethered aphids were connected to the aboveground electrode and the wire was manipulated to allow the aphid contact with the plant. Two H. axyridis adults (mixed sex) were caged inside of metal mesh tea infusers (11.98 cm×2.99 cm×2.36 cm) with moist cotton and placed approximately 8 cm from the wired aphids. Control runs were completed using tea infusers containing only moist cotton and run separately from the treatment assays to avoid cross contamination of volatiles. Aphid probing and feeding behaviors were recorded for 8 hours using the Stylet+software (EPG Systems, Wageningen, Netherlands). Recordings were only included in the final analysis if a minimum of 3 hours of activity was captured. Additionally, recordings were not included if combined xylem feeding, derailed stylet mechanics, and non-probing duration was >70% of the total reading to avoid increasing the variability of other predictor behaviors. Resulting waveforms from the remaining recordings (predator absent=18; predator present=17) were characterized using Stylet+A (EPG Systems, Wageningen, Netherlands), and the labels were converted into either time spent in each feeding phase or number of incidences of an action using an automatic parameter calculating macro (Sarria et al., 2009). Since the data did not meet the assumptions required for parametric procedures, differences in phloem salivation (E1), phloem ingestion (E2), and xylem feeding (G), the number of cell probes (pd), and the time to first sustained (>10 min) phloem ingestion (E2) between the predator treatments and the controls were assessed using a non-parametric Mann-Whitney test (R. 2022.02.2).

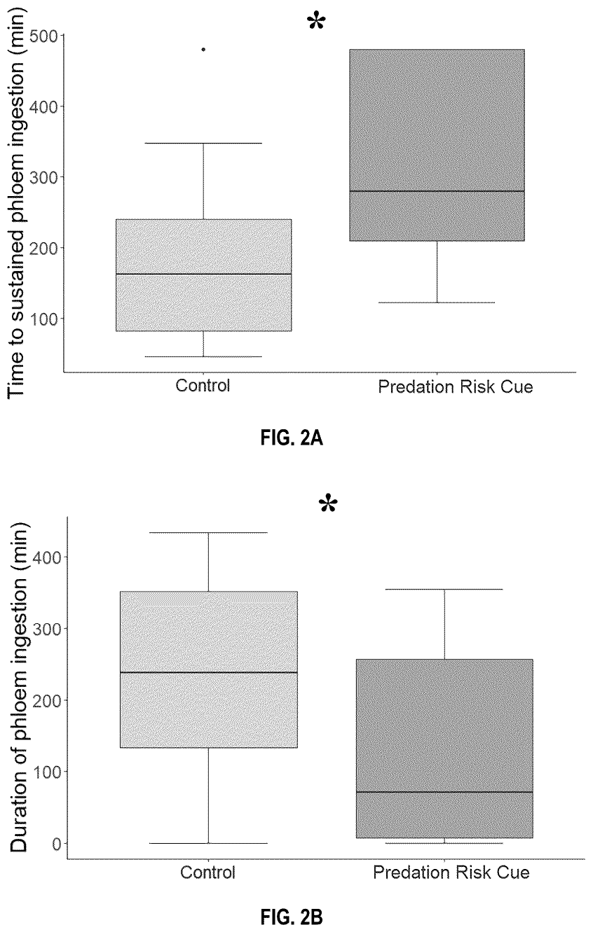

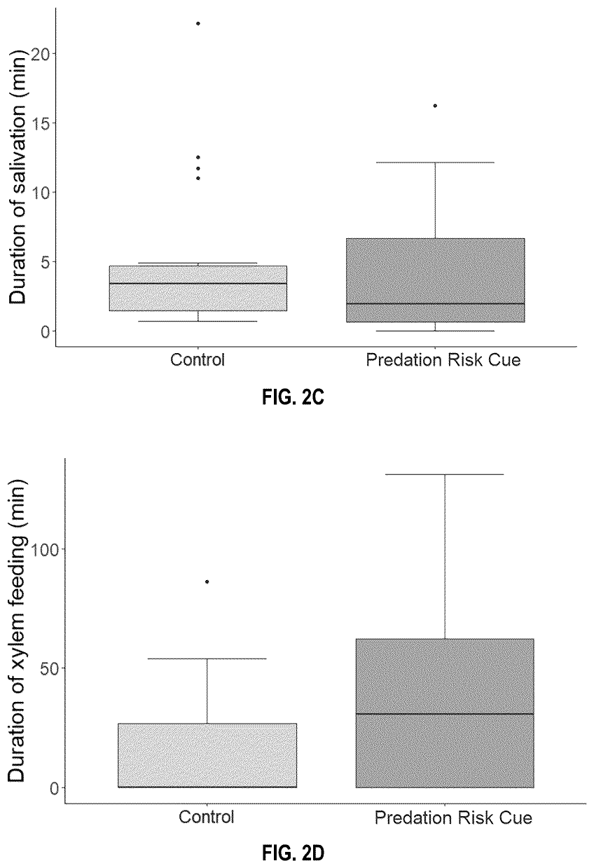

In the presence of H. axyridis odor cues, aphids took longer to begin sustained phloem feeding (time to sustained ingestion, W=65, p=0.004, FIG. 2A), and subsequently fed for a shorter duration of time (phloem ingestion (E2) W=219.5 p=0.029, FIG. 2B). Phloem salivation was not affected by predator presence (FIG. 2C). Predation risk also increased the duration of xylem ingestion (G, W=97, p=0.051. FIG. 2D), and aphids were 25% more likely to xylem feed in the presence of predators. No other measured feeding behaviors were affected by predation risk.

Predation Risk Did not Influence Aphid within-Plant Movement

The settling behavior of M. persicae aphids in response to H. axyridis odor cues was evaluated on individual Brassica plants in a greenhouse (Scent Mediation Ecology Laboratory; Penn State University; LD: 16:8, 20-24° C.). One adult, wingless aphid was placed on the underside of a leaf by rotating the leaf and holding it in place. After allowing the aphid to settle for 10 minutes, the leaf was turned over and two caged H. axyridis adults (mixed sex) were placed directly below the aphids. Metal mesh tea infusers were used to cage the beetles, and moist cotton was provided as a water source. Control treatments consisted of metal mesh tea infusers with only moist cotton inside. An acetate cylinder (˜30 cm) was placed around the plant to cage the aphids. After 24 hours, whether the aphid moved off of the leaf it had initially settled on was evaluated (n=50). Aphids that moved to the top of the same leaf they were placed on were removed from the study as it was difficult to distinguish whether this move occurred before predators were added (n=4). Aphid choice to leave the leaf closest to the caged predators were compared between treatments using a chi-square analysis, using the predicted choice values determined based on the decisions made in the control treatments (R. 2022.02.2).

H. axyridis odor cues did not affect aphid within-plant movement (χ²=0.621, df=1, p=0.431). Only 20-25% of aphids chose to settle on a different leaf than the one they were placed on, regardless of treatment.

### Predation Risk Did not Influence Aphid Between-Plant Movement

The dispersal behavior of M. persicae in response to H. axyridis odor cues between plants was evaluated in a greenhouse (Scent Mediation Ecology Laboratory, Penn State University; LD: 16:8, 20-24° C.). Three-week-old Brassica plants were transplanted into rectangular planting trays (50.8 cm×25.4 cm, Hummert International, Earth City, MO, USA) in a row of 4 plants, each spaced ˜10 cm apart. The collard transplants were allowed to acclimate for 1 week before 10 aphids, either winged or wingless, were added to the first plant at the beginning of the row (the starting plant). Aphids were caged on the starting plant using a 30 cm tall acetate ring with a mesh top to restrict aphid movement. After 24 hours, the acetate ring was removed and two H. axyridis adults, mixed sex, caged in metal mesh tea infusers with moist cotton as a water source were placed directly below the starting plants. Control treatments consisted of metal mesh tea infusers containing only moist cotton placed below the starting plant. This design resulted in four treatment combinations of aphid wing condition and predator presence/absence (wingless+control n=15; wingless+predator n=18; winged+control n=18; winged+predator n=18). This study was repeated to increase replication and incorporated as a temporal block, however, block was not significant and dropped from the final analysis. Aphid dispersal was assessed at 24 hr by counting how many aphids were on each plant 1-4 (1 being the starting plant), and then assessing the average number of plants away from the source plants the aphids were located (methods from Long & Finke, 2015). Ultimately, aphid dispersal was minimal and random across plants, regardless of treatment or aphid morph. To demonstrate this, we calculated the proportion of aphids that chose to disperse from the starting plant in the presence or absence of lady beetle cues separately each aphid morph using a likelihood ratio χ2 test derived from a generalized linear (binomial logit link) model (R. 2022.02.2).

Aphid dispersal from the release plant was not affected by H. axyridis odor cues for either winged or wingless morphs (winged χ²=0.733, df=1, p=0.392; wingless χ²=0.001, df=1, p=0.969). Aphids did not disperse across plants much within the experiment, and the distance aphids moved away from the predator odor cues was entirely random and not affected by the presence of caged H. axyridis in this design.

### Predation Risk Reduced Aphid Population Size

Aphid population growth in the presence of H. axyridis odor cues was assessed in a greenhouse (Scent Mediation Ecology Laboratory, Penn State University; LD: 16:8, 20-24° C.). Brassica plants were grown in a greenhouse for 3 weeks before use in the study and fertilized weekly (OSMOCOTE®, Scotts Miracle-Gro). Each collard plant was placed in an individual bug dorm (model BugDorm-2120, Mega View Science Co. Ltd, Taichung, Taiwan) and inoculated with 15 wingless, adult M. persicae. Three adult H. axyridis (mixed sex, randomized female:male ratio across treatments) were caged in metal tea infusers with moist cotton as a water source and placed at the base of the collard plants in half of the cages (predator n=19, control n=19). To avoid odor contamination between treatment and controls, cages were placed >3 meters apart. Aphid abundance was counted 8 days after aphids were added to the plants. Differences in aphid population abundance between the control treatment and the caged lady beetle treatment were assessed using a non-parametric Mann-Whitney test (RStudio 2022.02.2).

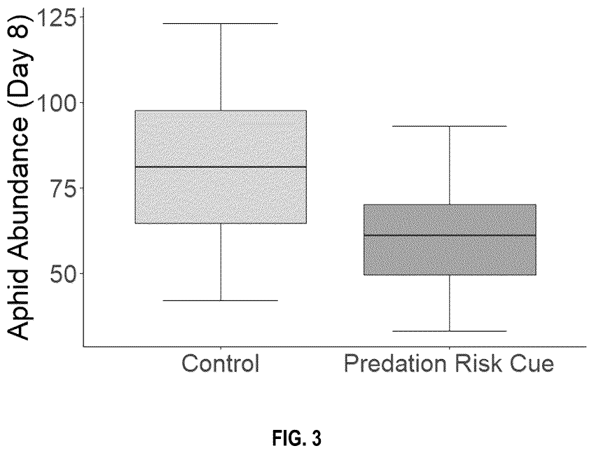

The presence of H. axyridis odor cues significantly reduced aphid population size (F_{1,36}=10.34, p=0.003, FIG. 3). Following one week of lady beetle odor cue exposure in this experiment, aphid populations were reduced by 25% compared to the predator cue-free control.

### DISCUSSION

To avoid being eaten, prey initiate a diverse suite of anti-predator trait changes. These trait changes can have significant consequences for prey population size and other behaviors that contribute to their success. Most studies focus on individual trait changes, which can be suggestive of potential population-level changes but do not directly connect how anti-predator behaviors affect populations. The results of this example found reduced aphid population size when exposed to caged H. axyridis, which may be driven by the observation that aphids ingest less phloem sap and take a longer time to establish feeding sites in the presence of lady beetle odor cues. However, predator cues did not influence dispersal: when caged H. axyridis were placed near aphids already settled on plants, aphids did not distance themselves from the odor cues within plants or between plants in a larger arena. These observations create an interesting paradox, where aphids are experiencing significant fitness consequences by being near lady beetle odor cues, and yet the aphids are not choosing to disperse away from the threatening odors when given the opportunity. Understanding both trait changes and cascading effects on populations increases our predictive power when thinking about predator-prey dynamics.

Non-consumptive effects can reduce prey populations when prey reallocate more energy into risk-averse behaviors than into reproduction. Reducing feeding in exchange for increased vigilance is a common predator-induced behavior, observed in macrofauna grazing in the grassland to beetles feeding on plant tissues. Reduced feeding may allow aphids to more quickly abandon feeding sites when a predator approaches. Indeed, it has been shown that caterpillars were more vulnerable to predation while actively feeding compared to resting. Additionally, M. persicae has been shown to elicit defensive behaviors in response to predation risk, such as running away or producing secretions in the cornicles, likely alarm pheromones. It is unclear if these behaviors were happening in these experiments, or if investments were made within the aphids to prepare for these defensive behaviors in just the presence of odor cues without a physical predator approaching the aphids. A trend for increased xylem ingestion in the presence of H. axyridis odors was observed which could indicate increased osmoregulation demands in response to stress. Other studies have shown aphids increase production of dispersal-ready winged morphs in the presence of predator odors, which are less fecund than their wingless counterparts and are primarily responsible for long-range dispersal. However, an increased presence of winged morphs was not responsible for the decline in population growth in this study, as differences in winged aphid production were not observed over the one-week experiment timeframe. These results suggest that reduced phloem ingestion is at least partially responsible for the reduced fitness of M. persicae in the presence of H. axyridis odor cues.

Increased movement is incredibly costly to aphid reproductive capacity and may allow detection by predators. Aphids reproduce asexually and feed on the constantly flowing phloem sap, so they often have no reason to leave feeding sites from birth to death. If aphids need to relocate, they must undergo a time-intensive process to establish a new feeding site, first laying down gel-like saliva to mount the outer sheath of their stylet before weaving their flexible stylet in between plant cells to find the phloem. Despite the cost, aphids have been shown to abandon feeding sites and disperse away from predators when predators were allowed to make contact with the aphids, even when the predators were rendered non-lethal. Additionally, M. persicae have been shown to avoid host-plants harboring H. axyridis in two-choice olfactometer studies, though interestingly winged aphids preferred to orient toward predator odor cues. Therefore, M. persicae may have an altered behavioral strategy when predator cues are detected after already settling on a plant as opposed to initial host choice and colonization. Implementing a shelter-in-place strategy may ultimately benefit aphid survival if it allows them to go unnoticed by the predator, initiating dispersal and escape strategies after the threat has passed or by stimulating wing production as shown in prior research in this system.

To our knowledge, our study is one of the first to show that aphid feeding behavior is affected by predation risk and the first to show that predator odor cues, in particular, affect aphid feeding. Aphids took significantly longer to establish feeding in the phloem in the presence of predators, and subsequently fed for less time. However, an increase in salivation events with the aphids was not observed, which is notable since salivation plays a vital role for aphids in both overcoming plant defensive responses and in transmitting plant pathogens. Increased aphid movement in combination with successful feeding could increase virus spread between plants, however, other studies have shown predation risk reduces pathogen transmission. Indeed, since increased aphid movement or increased salivation time were not observed, this could suggest that aphid response to predation may not increase the transmission of pathogens, especially those with long acquisition and inoculation times, highlighting that the intersection of non-consumptive effects and virus transmission is an important avenue for future research.

Despite being understudied in insect systems, non-consumptive effects are significant drivers of population dynamics between predators and their prey. Reduced aphid population size in the presence may be driven by reduced phloem ingestion, however, the reduced phloem ingestion was not due to increased movement behaviors of the aphids away from predator odor cues. Although reduced aphid populations and reduced feeding were observed indicating that aphids were responding to predation risk, what, if any, survival tactics the aphids were investing in have yet to be uncovered. This disparity opens up a suite of future directions on whether some of these responses to predation risk are maladaptive and whether they benefit survival in the end. Since aphids are significant crop pests worldwide, many applied research projects are assessing ways to control these aphid pests in sustainable ways. The work suggests that the presence of lady beetle odor cues alone may serve as a method to reduce aphid populations, at least short term, and could be a promising technique warranting further exploration.

### Example 4: Harmonia axyridis Produces a Suite of Volatile Odors

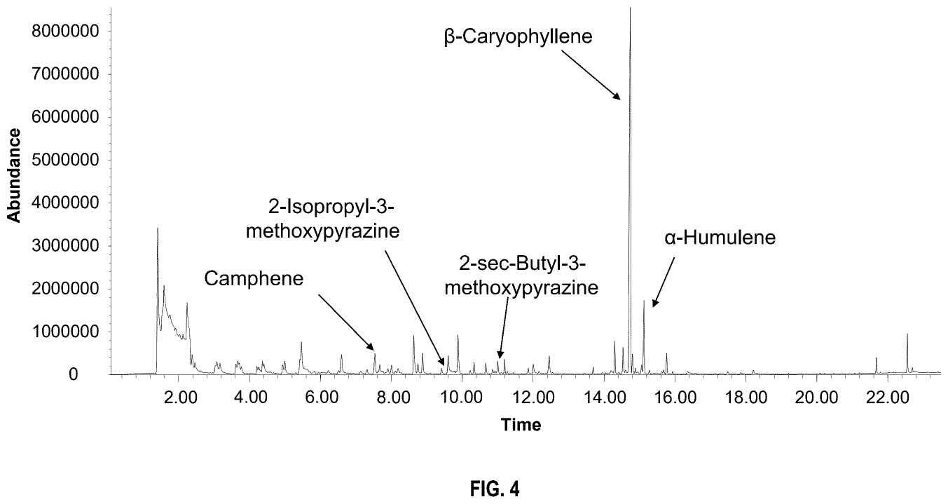

In order to elucidate the blend of odor cues produced by H. axyridis, volatile odors were collected from live adult ladybeetles. To do this, the volatiles of 80 H. axyridis within a glass jar for 24 hours on a HAYSEP-Q trap were collected using a push-pull volatile collection system. The resulting collection was eluted using dichloromethane analyzed using a gas chromatograph mass spectrometer (FIG. 4). The individual compounds identified included three methoxypyrazines documented to stimulate behavioral changes in aphids, and several other bioactive candidate compounds. The compounds identified are summarized in Table 1.

TABLE 1

| Compound | CAS Number |
|---|---|
| 2-Isobutyl-3-methoxypyrazine | 24683-00-9 |
| 2-Isopropyl-3-methoxypyrazine | 025773-40-4 |
| 2-sec-Butyl-3-methoxypyrazine | 080090-53-5 |
| Octadecanoic acid | 000057-11-4 |
| Dimethyl sulfone | 000067-71-0 |
| Camphene | 000079-92-5 |
| α-Pinene | 000080-56-8 |
| β-Caryophyllene | 000087-44-5 |
| 1,2,4-Trimethylbenzene | 000095-63-6 |
| Styrene | 000100-42-5 |
| Benzene acetic acid methyl ester | 000101-41-7 |
| Propylbenzene | 000103-65-1 |
| 2-Ethyl-1-hexanol | 000104-76-7 |
| Caprolactam | 000105-60-2 |
| Mesitylene | 000108-67-8 |
| 2-Heptanone | 000110-43-0 |
| 2-Octanone | 000111-13-7 |
| 1-Octanol | 000111-87-5 |
| Eicosane | 000112-95-8 |
| Tetracosane | 000112-95-8 |
| Indole | 000120-72-9 |
| 3-Methyl-1-butanol | 000123-51-3 |
| Decane | 000124-18-5 |
| Limonene | 000138-86-3 |
| 1,4-Diethylbenzene | 000141-93-5 |
| Dodecanoic acid | 000143-07-7 |
| Cyclopentadecane | 000295-48-7 |
| Indane | 000496-11-7 |
| Borneal | 000507-70-0 |
| 2,3-Butanediol | 000513-85-9 |
| Acetoin | 000513-86-0 |
| o-Cymene | 000527-84-4 |
| Tetrahydro-2H-pyran-2-one | 000542-28-9 |
| 3-(Methylthio)-1-propanol | 000557-22-2 |
| Terpinolene | 000586-62-9 |
| 2,3,3-Trimethyl-1-butene | 000594-56-9 |
| Pentadecane | 000629-62-9 |
| Heneicosane | 000629-94-7 |
| Docosane | 000629-97-0 |
| Pentacosane | 000629-99-2 |
| Hentriacotane | 000630-04-6 |
| 2-Nonanone | 000821-55-6 |
| 1-Ethyl-2,3-dimethylbenzene | 000933-98-2 |
| Dimethylsilanediol | 001066-42-8 |
| 4-Unadecanone | 001604-34-8 |
| Dehydromevalonic lactone | 002381-87-5 |
| Methyl ester octadeca-9,12-dienoate | 002462-85-3 |
| Geranyl acetone | 003796-70-1 |
| (Z)-3,7-Dimethyl-3,6-octadien-1-ol | 005944-20-7 |
| 1,3,5-Tris(trimethylsiloxy)benzene | 010586-12-6 |
| 6-Methyl-3,4-dihydro-2H-pyran | 016015-11-5 |
| 5-Butylnonane | 017312-63-9 |
| 1-Hexacosene | 018835-33-1 |
| S-Methyl 3-methylbutanethioate | 023747-45-7 |
| 4-Hydroxy 3-(methylamino)benzonitrile | 031600-69-8 |
| Camphene hydrate | 064474-11-9 |
| 3,7 Dimethyl-6-noen-1-ol acetate | 085877-56-1 |
| 4-(3-Hydroxy-2,2,6-trimethyl-7-oxa- | 1000190-36-6 |
| bicyclo[4.1.0]hept-1-y1)-but-3-en-2-one | |
| 2-Hydrazino-4,6-dimethylpyrimidine, 2TMS | 1000332-01-7 |
| derivative, peak 2 | |
| 1-Iodododecane | 1000406-31-9 |
| α-Humulene | 0006753-98-6 |

### Example 5: Aphid Neuronal Bioactivity

Aphid neuronal bioactivity in response to lady beetle volatiles will be assessed to discern what specific compounds are used by aphids to detect lady beetles. To confirm whether aphids demonstrate an electrophysiological response to predator odor cues and determine which specific compounds are responsible for bioactivity, the GC/EAG technique (coupled gas chromatography-electroantennography) will be used. This technique evaluates insect antennal response to odor cues by recording the electrical potential from antennae connected to an amplified electrical circuit as different volatiles elute from the GC and flow over the antenna. By exposing aphid antennae to the predator odor blend, the aphids' ability to detect the individual compounds in the H. axyridis emanations will be assessed.

### Example 6: Volatile Collection and Blend Formulation from Ladybeetle

Headspace volatiles were collected from live ladybeetles using a headspace collection system. Collected compounds were analyzed using gas chromatography-mass spectrometry (GC-MS) to identify over 50 volatile compounds. A literature review was performed to shortlist and filter the important compounds that aphids would respond to. Five different blends (Blends A, B, C, D and E) of shortlisted compounds were created mainly composing of different terpenes and methoxypyrazines (Table 2).

TABLE 2

| Blend | Compounds |
|---|---|
| Blend A | Isopropyl methoxypyrazine, 2-methoxy-3-isobutylpyrazine, 3- |
| | sec-isobutyl 2-methoxypyrazine, b-caryophyllene, -(+) |
| | limonene, a-pinene, a-humulene |
| Blend B | Isopropyl methoxypyrazine, 2-methoxy-3-isobutylpyrazine, 3- |
| | sec-isobutyl 2-methoxypyrazine, b-caryophyllene, -(+) |
| | limonene, a-pinene |
| Blend C | Isopropyl methoxypyrazine, 2-methoxy-3-isobutylpyrazine, 3- |
| | sec-isobutyl 2-methoxypyrazine, b-caryophyllene, -(+) |
| | limonene |
| Blend D | Isopropyl methoxypyrazine, 2-methoxy-3-isobutylpyrazine, 3- |
| | sec-isobutyl 2-methoxypyrazine, b-caryophyllene |
| Blend E | Isopropyl methoxypyrazine, 2-methoxy-3-isobutylpyrazine, 3- |
| | sec-isobutyl 2-methoxypyrazine |

### Example 7: Choice Data with Winged Aphid Adults

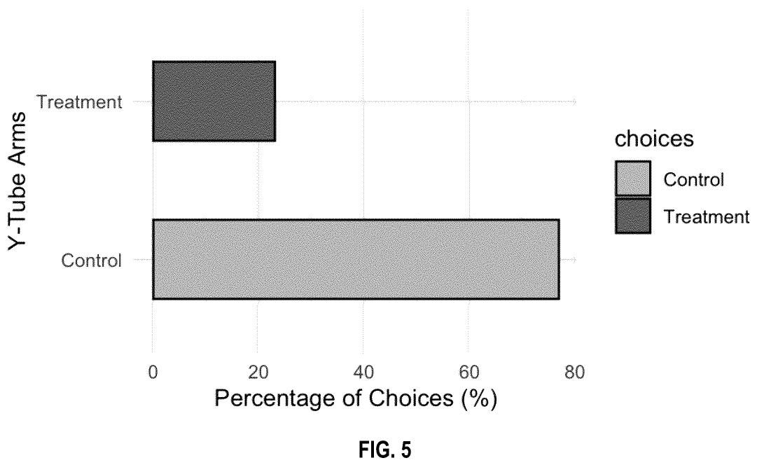

A Y-tube olfactometer was used to assess aphid preference between predator volatile blends and solvent control. The response of two aphid morphotypes (wing and wingless) to blends A-E was tested. Aphids were introduced at the base of the Y-tube and given 5 minutes to choose between airflows containing a test blend or a solvent control air. Aphids showed no significant response to blends A-D, which contained the most diverse blends of compounds detected from ladybeetle predators. Blend E, containing the methoxy pyrazines, caused significant aphid-repellance (FIG. 5).

### Example 8: Aphid Distribution Assay

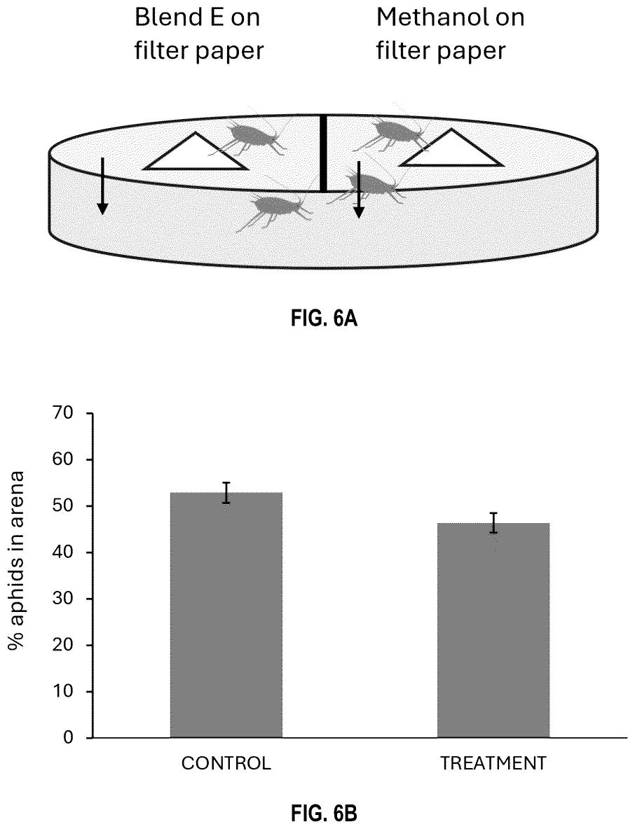

A petri dish was divided into two sections: one half contained filter paper with predator odor blend; the other half contained methanol solvent (control) (FIG. 6A). Aphids were placed in the center of the dish and left undisturbed for 30 minutes. The aphid distribution in each arena was measured at the end of the experiment. A significantly higher number of aphids moved towards the control side, confirming the repellency to blend E (FIG. 6B).

### Example 9: Field Experiment on Broccoli Plants

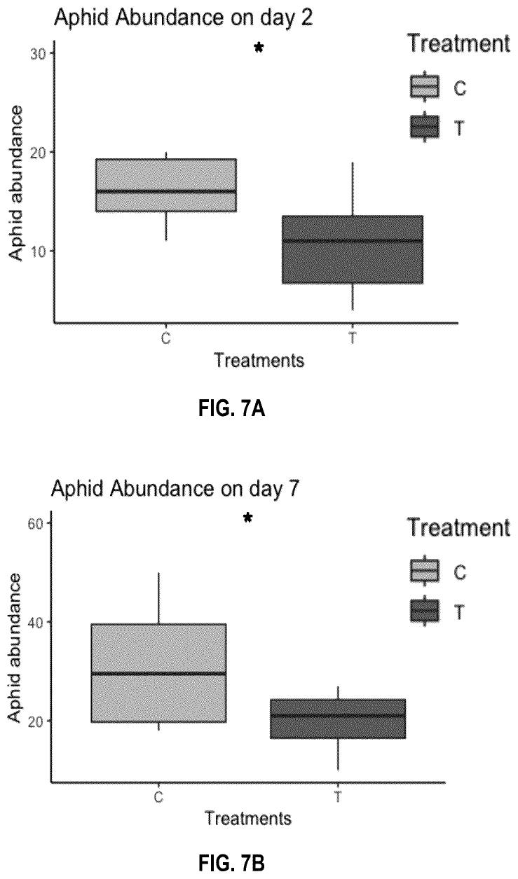

Broccoli plants were grown in field plots. Mesh bags containing live ladybeetles were placed over designated plants to allow the release of volatile emissions without direct predation on aphids. Control plants had empty mesh bags. Aphid populations were recorded at 2 days (FIG. 7A) and 7 days post-exposure (FIG. 7B). Aphid populations were lower on plants exposed to ladybeetle volatiles than control plants, suggesting a physiological response resulting in reduced fecundity in the presence of volatile predator odor cues.

### REFERENCES

Ayasse, M., Paxton, R. J., & Tengo, J. (2001). Mating behavior and chemical communication in the order Hymenoptera. Annual Review of Entomology, 46 (1), 31-78.
Basu, S., Clark, R. E., Fu, Z., Lee, B. W., & Crowder, D. W. (2021). Insect alarm pheromones in response to predators: Ecological trade-offs and molecular mechanisms. Insect Biochemistry and Molecular Biology, 128, 103514.
Bernays, E. A. (1997). Feeding by lepidopteran larvae is dangerous. Ecological Entomology, 22 (1), 121-123.
Clark, R. E., Basu, S., Lee, B. W., & Crowder, D. W. (2019). Tri-trophic interactions mediate the spread of a vector-borne plant pathogen. Ecology, 100 (11), 1-8.
Cudjoe, E., Wiederkehr, T. B., & Brindle, I. D. (2005). Headspace gas chromatography-mass spectrometry: a fast approach to the identification and determination of 2-alkyl-3-methoxypyrazine pheromones in ladybugs. Analyst, 130 (2), 152-155.
Culshaw-Maurer, M., Sih, A., & Rosenheim, J. A. (2020). Bugs scaring bugs: enemy-risk effects in biological control systems. Ecology Letters, 23 (11), 1693-1714.
Finke, D. L. (2012). Contrasting the consumptive and non-consumptive cascading effects of natural enemies on vector-borne pathogens. Entomologia Experimentalis et Applicata, 144 (1), 45-55.
Hardie, J., Gibson, G., & Wyatt, T. D. (2001). Insect behaviours associated with resource finding. Insect Movement: Mechanisms and Consequences. Proceedings of the Royal Entomological Society's 20th Symposium, London, UK, September 1999, 87-109.
Hermann, S. L., Bird, S. A., Ellis, D. R., & Landis, D. A. (2021). Predation risk differentially affects aphid morphotypes: impacts on prey behavior, fecundity and transgenerational dispersal morphology. Oecologia, 197 (2), 411-419.
Hermann, S. L., & Landis, D. A. (2017). Scaling up our understanding of non-consumptive effects in insect systems. Current Opinion in Insect Science, 20, 54-60.
Hermann, S. L., & Thaler, J. S. (2014). Prey perception of predation risk: volatile chemical cues mediate non-consumptive effects of a predator on a herbivorous insect. Oecologia, 176 (3), 669-676.
Huberty, A. F., & Denno, R. F. (2006). Trade-off in investment between dispersal and ingestion capability in phytophagous insects and its ecological implications. Oecologia, 148 (2), 226-234.
Ingerslew, K. S., & Finke, D. L. (2017). Mechanisms underlying the nonconsumptive effects of parasitoid wasps on aphids. Environmental Entomology, 46 (1), 75-83.
Kersch-Becker, M. F., & Thaler, J. S. (2015). Plant resistance reduces the strength of consumptive and non-consumptive effects of predators on aphids. Journal of Animal Ecology, 84 (5), 1222-1232.
Laundré, J. W., Hernández, L., & Altendorf, K. B. (2001). Wolves, elk, and bison: reestablishing the “landscape of fear” in Yellowstone National Park, U.S.A. Canadian Journal of Zoology, 79 (8), 1401-1409.
Lee, B. W., Basu, S., Bera, S., Casteel, C. L., & Crowder, D. W. (2021). Responses to predation risk cues and alarm pheromones affect plant virus transmission by an aphid vector. Oecologia, 196 (4), 1005-1015.
Lima, S. L., & Dill, L. M. (1990). Behavioral decisions made under the risk of predation: a review and prospectus. Canadian Journal of Zoology, 68 (4), 619-640.
Long, E. Y., & Finke, D. L. (2015). Predators indirectly reduce the prevalence of an insect-vectored plant pathogen independent of predator diversity. Oecologia, 177 (4), 1067-1074.
Mauck, K., Bosque-Pérez, N. A., Eigenbrode, S. D., De Moraes, C. M., & Mescher, M. C. (2012). Transmission mechanisms shape pathogen effects on host-vector interactions: evidence from plant viruses. Functional Ecology, 26 (5), 1162-1175.
Michaud, J. P. (2012). Coccinellids in biological control. Ecology and Behaviour of the Ladybird Beetles (Coccinellidae). John Wiley & Sons, Chichester, 488-519.
Müller, C., Caspers, B. A., Gadau, J., & Kaiser, S. (2020). The Power of Infochemicals in Mediating Individualized Niches. Trends in Ecology & Evolution, 35 (11), 981-989.
Nalam, V., Louis, J., Patel, M., & Shah, J. (2018). Arabidopsis-Green Peach Aphid Interaction: Rearing the Insect, No-choice and Fecundity Assays, and Electrical Penetration Graph Technique to Study Insect Feeding Behavior. Bio-Protocol, 8 (15).
Nalam, V., Louis, J., & Shah, J. (2019). Plant defense against aphids, the pest extraordinaire. Plant Science, 279 (May 2018), 96-107.
Nelson, E. H. (2007). Predator avoidance behavior in the pea aphid: Costs, frequency, and population consequences. Oecologia, 151 (1), 22-32.
Ninkovic, V., Feng, Y., Olsson, U., & Pettersson, J. (2013). Ladybird footprints induce aphid avoidance behavior. Biological Control, 65 (1), 63-71.
Peacor, S. D., Dorn, N. J., Smith, J. A., Peckham, N. E., Cherry, M. J., Sheriff, M. J., & Kimbro, D. L. (2022). A skewed literature: Few studies evaluate the contribution of risk effects to natural field patterns. June 1-14.
Peacor, S. D., Peckarsky, B. L., Trussell, G. C., & Vonesh, J. R. (2013). Costs of predator-induced phenotypic plasticity: A graphical model for predicting the contribution of nonconsumptive and consumptive effects of predators on prey. Oecologia, 171 (1), 1-10.
Powell, G., Pirone, T., & Hardie, J. (1995). Aphid stylet activities during potyvirus acquisition from plants and anin vitro system that correlate with subsequent transmission. European Journal of Plant Pathology, 101 (4), 411-420.
Preisser, E. L., Bolnick, D. I., & Benard, M. E. (2005). Scared to Death? The effects of intimidation and consumption in predator-prey interactions. Ecology, 86 (2), 501-509.
Sarria, E., Cid, M., Garzo, E., & Fereres, A. (2009). Excel Workbook for automatic parameter calculation of EPG data. Computers and Electronics in Agriculture, 67 (1-2), 35-42.
Sheriff, M. J., Peacor, S. D., Hawlena, D., & Thaker, M. (2020). Non-consumptive predator effects on prey population size: A dearth of evidence. Journal of Animal Ecology, 89 (6), 1302-1316.
Vandereycken, A., Durieux, D., Joie, E., Sloggett, J. J., Haubruge, E., & Verheggen, F. J. (2013). Is the multicolored Asian ladybeetle, Harmonia axyridis, the most abundant natural enemy to aphids in agroecosystems? Journal of Insect Science, 13 (1), 158.
Vandermoten, S., Mescher, M. C., Francis, F., Haubruge, E., & Verheggen, F. J. (2012). Aphid alarm pheromone: An overview of current knowledge on biosynthesis and functions. Insect Biochemistry and Molecular Biology, 42 (3), 155-163.
Vet, L. E. M., & Dicke, M. (1992). Ecology of infochemical use by natural enemies in a tritrophic context. Annual Review of Entomology, 37 (1), 141-172.
Wilson, M. R., & Leather, S. R. (2012). The effect of past natural enemy activity on host-plant preference of two aphid species. Entomologia Experimentalis et Applicata, 144 (2), 216-222.
Züst, T., & Agrawal, A. A. (2016). Mechanisms and evolution of plant resistance to aphids. Nature Plants, 2 (January), 1-9.

What is claimed is:

1. An insect repellant composition that alters herbivorous insect behavior comprising: a methoxypyrazine that is produced by Harmonia axyridis; and an agriculturally acceptable carrier.

2. The composition of claim 1, wherein the methoxypyrazine comprises 2-isopropyl-3-methoxypyrazine, 2-sec-butyl-3-methoxypyrazine, or 2-isobutyl-3-methoxypyrazine.

3. The composition of claim 1, further comprising a terpene that is produced by H. axyridis.

4. The composition of claim 3, wherein the terpene comprises β-caryophyllene, α-humulene, limonene, or α-pinene.

5. The composition of claim 1, wherein the composition further comprises one or more of: octadecanoic acid; dimethyl sulfone; camphene; 1,2,4-trimethylbenzene; styrene; benzene acetic acid methyl ester; propylbenzene; 2-ethyl-1-hexanol; caprolactam; mesitylene; 2-heptanone; 2-octanone; 1-octanol; eicosane; tetracosane; indole; 3-methyl-1-butanol; decane; 1,4-diethylbenzene; dodecanoic acid; cyclopentadecane; indane; borneal; 2,3-butanediol; acetoin; o-cymene; tetrahydro-2H-pyran-2-one; 3-(methylthio)-1-propanol; terpinolene; 2,3,3-trimethyl-1-butene; pentadecane; heneicosane; docosane; pentacosane; hentriacotane; 2-nonanone; 1-ethyl-2,3-dimethylbenzene; dimethylsilanediol; 4-unadecanone; dehydromevalonic lactone; methyl ester octadeca-9,12-dienoate; geranyl acetone; (Z)-3,7-dimethyl-3,6-octadien-1-ol; 1,3,5-tris(trimethylsiloxy)benzene; 6-methyl-3,4-dihydro-2H-pyran; 5-butylnonane; 1-hexacosene; S-methyl 3-methylbutanethioate; 4-hydroxy 3-(methylamino)benzonitrile; camphene hydrate; 3,7 dimethyl-6-noen-1-ol acetate; 4-(3-hydroxy-2,2,6-trimethyl-7-oxa-bicyclo[4.1.0]hept-1-yl)-but-3-en-2-one; 2-hydrazino-4,6-dimethylpyrimidine, 2TMS derivative; 1-oodododecane.

6. The composition of claim 1, wherein the herbivorous insect is a soft-bodied insect preyed upon by H. axyridis.

7. The composition of claim 1, wherein the herbivorous insect is an aphid, scale, mealy bug, leaf hopper, or mite.

8. The composition of claim 1, wherein the composition further comprises a surfactant, a thickening agent, a plant nutrient, or a preservative.

9. The composition of claim 1, wherein the composition is formulated as a liquid, a solid, an aerosol, a paste, a gel, or a gas composition.

10. The composition of claim 1, wherein the carrier is water, a wax, a gel, an absorbent solid material capable of having the composition adsorbed thereon, or a solid matrix capable of having the composition contained therein.

11. A method of repelling herbivorous insects from a plant, the method comprising: delivering to the plant or plant area an insect repellent composition comprising a methoxypyrazine that is produced by H. axyridis; and an agriculturally acceptable carrier.

12. The method of claim 11, wherein the methoxypyrazine comprises 2-isopropyl-3-methoxypyrazine, 2-sec-butyl-3-methoxypyrazine, or 2-isobutyl-3-methoxypyrazine.

13. The method of claim 11, wherein the composition further comprises a terpene that is produced by H. axyridis.

14. The method of claim 11, wherein the terpene comprises β-caryophyllene, α-humulene, limonene, or α-pinene.

15. The method of claim 11, wherein the composition further comprises one or more of: octadecanoic acid; dimethyl sulfone; camphene; 1,2,4-trimethylbenzene; styrene; benzene acetic acid methyl ester; propylbenzene; 2-ethyl-1-hexanol; caprolactam; mesitylene; 2-heptanone; 2-octanone; 1-octanol; eicosane; tetracosane; indole; 3-methyl-1-butanol; decane; 1,4-diethylbenzene; dodecanoic acid; cyclopentadecane; indane; borneal; 2,3-butanediol; acetoin; o-cymene; tetrahydro-2H-pyran-2-one; 3-(methylthio)-1-propanol; terpinolene; 2,3,3-trimethyl-1-butene; pentadecane; heneicosane; docosane; pentacosane; hentriacotane; 2-nonanone; 1-ethyl-2,3-dimethylbenzene; dimethylsilanediol; 4-unadecanone; dehydromevalonic lactone; methyl ester octadeca-9,12-dienoate; geranyl acetone; (Z)-3,7-dimethyl-3,6-octadien-1-ol; 1,3,5-tris(trimethylsiloxy)benzene; 6-methyl-3,4-dihydro-2H-pyran; 5-butylnonane; 1-hexacosene; S-methyl 3-methylbutanethioate; 4-hydroxy 3-(methylamino)benzonitrile; camphene hydrate; 3,7 dimethyl-6-noen-1-ol acetate; 4-(3-hydroxy-2,2,6-trimethyl-7-oxa-bicyclo[4.1.0]hept-1-yl)-but-3-en-2-one; 2-hydrazino-4,6-dimethylpyrimidine, 2TMS derivative; 1-oodododecane.

16. The method of claim 11, wherein the herbivorous insect is an aphid, scale, mealy bug, leaf hopper, or mite.

17. The method of claim 11, wherein the composition further comprises a surfactant, a thickening agent, a plant nutrient, or a preservative.

18. The method of claim 11, wherein the composition is formulated as a liquid, a solid, an aerosol, a paste, a gel, or a gas composition.

19. The method of claim 11, wherein the carrier is water, a wax, a gel, an absorbent solid material capable of having the composition adsorbed thereon, or a solid matrix capable of having the composition contained therein.

20. The method of claim 11, wherein the delivering is by spraying.
